(19) United States
(12) Patent Application Publication
(10) Pub. No.: US 2007/0235525 A1
(43) Pub. Date: Oct. 11, 2007

(54) Information accessing and conveying systems and methods

(75) Inventor: Trent Matthew Murch, Chicago, IL (US)

Correspondence Address: BRINKS HOFER GILSON & LIONE, P.O. BOX 10395, CHICAGO, IL, 60610, US

(73) Assignee: Nearnet LLC

(21) Appl. No.: 11/400,421

(22) Filed: Apr. 7, 2006

(51) Int. Cl. G06K 5/00; G06F 15/16

(52) U.S. Cl. 235/382; 709/217

(57) ABSTRACT

A method for transferring information between a first entity and a second entity The method includes presenting a set of information to which the first entity has access in a memory that is at a location that does not coincide with a location of the first entity and sending a code to the second entity. The code contains information that allows access to the set of information present in the memory.

### BACKGROUND OF THE INVENTION

1. Field of the Invention

The present invention relates to devices and methods that aid in accessing and/or conveying information of a particular entity.

2. Related Art

An individual often encounters situations where he or she wishes to exchange information with another individual or business. However, such information can be bulky to carry and so other arrangements need to be made in order for such an exchange to take place. For example, an individual may meet another person by chance and strike up a conversation regarding business. The individual often does not have his or her business card or resumé because it was forgotten and/or is inconvenient to carry. At this stage the individuals will agree to exchange the information at a later time via the mail or electronically. The agreement to exchange information can be forgotten and so a business opportunity is lost.

In addition, it is well known that various types of data, such as textual, video and audio data, can be transferred from one person to another. While it is known to transfer certain information between people via portable devices, there are times when the data involved takes up too much memory in the portable devices so the data cannot be transferred. In addition, in some cases the time to transfer the data can be too time consuming to be practicable. In these situations it is common for an individual to send such data from his or her computer over the internet to another individual's computer. Such a transfer is dependent on the individual having to be present at his or her computer in order to initiate the transfer. In addition, such a transfer typically requires that the sender know specific information about the recipient in order to transmit the data to the recipient.

### SUMMARY OF THE INVENTION

One aspect of the present invention regards a system for transferring information between a first entity and a second entity, the system including a set of information to which the first entity has access and the set of information is present in a memory that is at a location that does not coincide with a location of the first entity. An introduction device that includes a code, wherein the introduction device has a transmitter that sends the code to a receiver of the second entity, wherein the code contains information that allows access to the set of information present in the memory.

A second aspect of the present invention regards a method for transferring information between a first entity and a second entity. The method includes presenting a set of information to which the first entity has access in a memory that is at a location that does not coincide with a location of the first entity and sending a code to the second entity. The code contains information that allows access to the set of information present in the memory.

A third aspect of the present invention regards a memory system for enabling the transfer of information between a first entity and a second entity and enabling the first entity to manage information. The memory system including a memory in which is present a set of information to which the first entity has access and a system that assigns a code to the set of information, wherein the code contains information allowing a second entity that receives the code access to the set of information present in the memory. The memory system also includes an output for providing the code and an input for receiving a transmission having the code from a location external to the memory system. The memory system also includes a reading device that is in communication with the input and reads the code. The memory is in communication with the reading device, wherein upon reading the code the reading device allows access to the set of information to an entity that is located external to the memory system.

A fourth aspect of the present invention regards an introduction device for enabling the transfer of information between a first entity and a second entity, the introduction device including a memory that includes a code associated with a set of information to which the first entity has access, wherein the set of information is present in a memory system. The introduction device also has a transmitter in communication with the memory, the transmitter sends the code externally of the introduction device, wherein the code contains information allowing the second entity that receives the code access, upon transmission of the code to the memory system, to the set of information present in the memory system.

A fifth aspect of the present invention regards a receiving device for enabling the transfer of information between a first entity and a second entity, the receiving device including a receiver for receiving from a location external to the receiving device a code associated with a set of information to which the first entity has access, wherein the set of information is present in an external memory system. The receiving device further includes a memory that is in communication with the receiver and stores the code and a transmitter in communication with the memory, where the transmitter sends the code to the external memory system, and where the code contains information allowing the second entity that received the code access to the set of information present in the external memory system.

One or more aspects of the present invention provide the advantage of providing for real time access to data of one individual by another individual regardless of the size of data involved. Access to vast amounts of data can be transferred in an instant.

One or more aspects of the present invention provide the advantage of providing for access to vast amounts of data on devices with limited memory capacity.

One or more aspects of the present invention provide the advantage of providing for a system and method in which an individual can transfer data to one or more individuals without knowing any specific information as to the identity of the individuals or their devices.

One or more aspects of the present invention provide the advantage of providing for a system and method in which an individual can easily and automatically transfer information just received to numerous online accounts and/or devices in accordance with saved preferences, with no affirmative action required by the individual at the time of such transfer.

### BRIEF DESCRIPTION OF THE DRAWINGS

FIG. 1 schematically shows a first embodiment of an information access system in accordance with the present invention;

FIG. 2 schematically shows a block diagram for describing the embodiment of the information access system shown in FIG. 1;

FIG. 3 schematically shows a mode of use of the information access system of FIG. 2;

FIG. 4 schematically shows a second embodiment of an information access system in accordance with the present invention;

FIG. 5 schematically shows a third embodiment of an information access system in accordance with the present invention;

FIG. 6 schematically shows a fourth embodiment of an information access system in accordance with the present invention;

FIG. 7 schematically shows a fifth embodiment of an information access system in accordance with the present invention;

FIG. 8 schematically shows a mode of use of the information access system of FIG. 7;

FIG. 9 schematically shows a sixth embodiment of an information access system in accordance with the present invention;

FIG. 10 schematically shows a seventh embodiment of an information access system in accordance with the present invention;

FIG. 11 schematically shows an eighth embodiment of an information access system in accordance with the present invention;

FIG. 12 schematically shows a ninth embodiment of an information access system in accordance with the present invention;

FIG. 13 schematically shows a tenth embodiment of an information access system in accordance with the present invention; and

FIG. 14 schematically shows an eleventh embodiment of an information access system in accordance with the present invention.

### DETAILED DESCRIPTION OF THE DRAWINGS AND THE PRESENTLY PREFERRED EMBODIMENTS

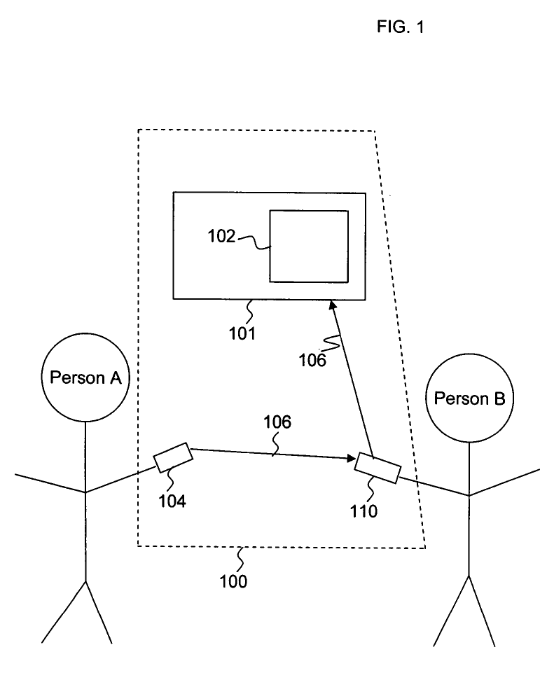

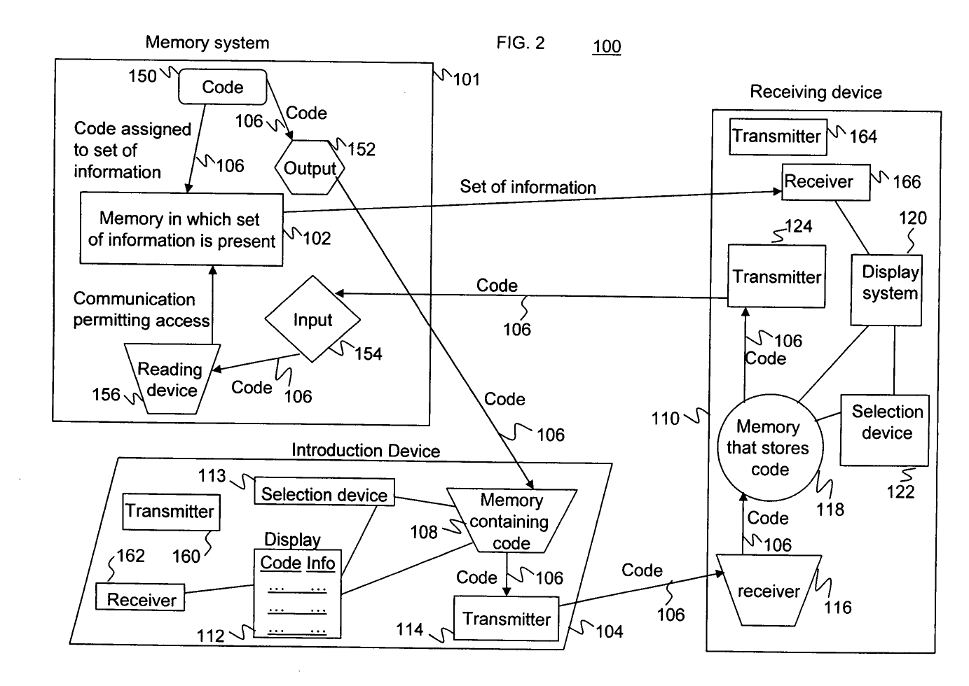

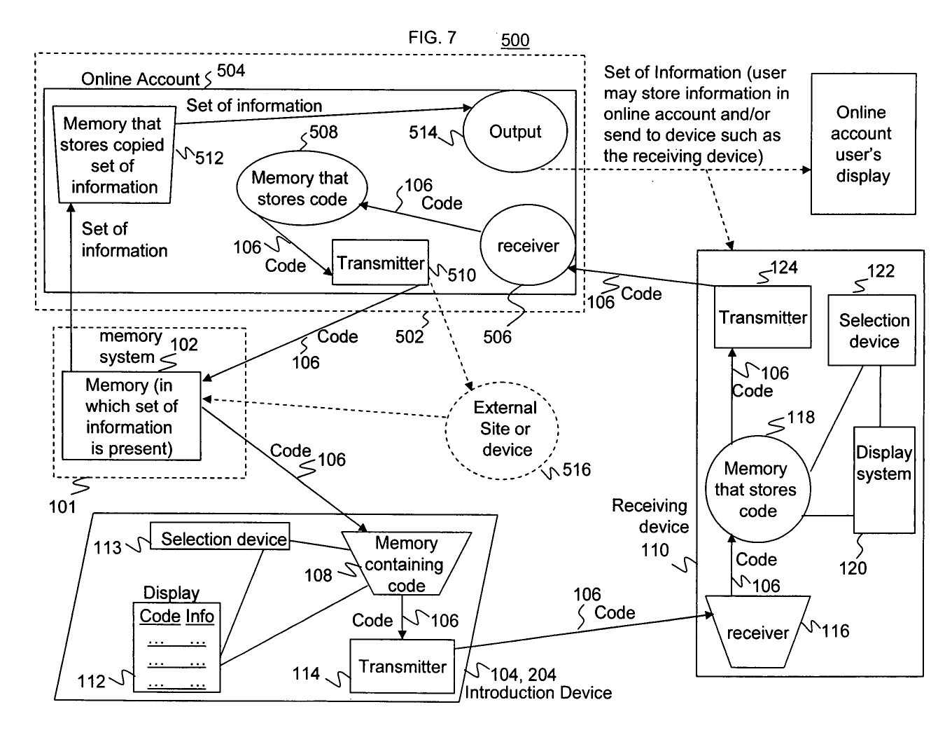

FIGS. 1-14 schematically show various embodiments of information access systems wherein like elements are denoted by like numerals. In particular, FIG. 1 schematically shows an embodiment of an information access system 100 that transfers information between a first entity, such as person A, and a second entity, such as person B. The information access system 100 includes a memory system 101 that includes a memory 102 that is located at a place that does not coincide with the location of person A. For example, the memory 102 may be present in either an online server that stores data contained in person A's online account 504 (this possibility will be discussed later with respect to the embodiments of FIGS. 7-11) or a personal computer located at his or her residence. The memory 102 includes a set of information to which person A has access. The set of information can be textual, visual and/or audio in nature. As shown in FIG. 2, the memory system 101 includes a code memory system 150 that generates and/or assigns and/or stores access codes 106 that are associated or are to be associated with certain sets of information present in memory 102. Note that assignment of access codes 106 can involve attachment to a set of information that is in a folder, wherein the folder could contain text, audio, video files, etc., within it, and the code would be like a folder name that is tied to all the associated data. If it is just one file, the code could be tied to it like a name (or a folder with one item in it). In another variation, the memory 102 may be present in person A's personal computer located at his or her residence.

As shown in FIGS. 1-2, the information access system 100 includes an introduction device 104 that includes a code 106 stored in a memory 108 of the introduction device 104. The code 106 is associated with the set of information so as to allow access to the set of information present in the memory 102. The code 106 can include an alphanumeric sequence and/or any other data or information and can be in computer readable form.

The introduction device 104 can also include a transmitter 160 and a receiver 162 to send and receive signals, which may include wireless signals, such as BlueTooth signals, that may or may not be related to accessing the set of information stored in the memory 102.

The introduction device 104 can take on many forms. For example, it can be incorporated into any known devices that can send signals containing information, such as cell phones, computers and PDA's. The introduction device 104 can be a stand alone device as well. The introduction device 104 can be portable. In particular, it can be in the form of jewelry worn by a person, such as a ring, watch, necklace, bracelet or a pin. In addition, an introduction device 104 can be incorporated into other devices, such as televisions, radios, satellite radios, cars, trucks, motorcycles or other vehicles, key fobs, CD players, DVD players, pens, pencils, non-cellular phones, ATM's, boats, subdermal implants, video cameras, nonvideo cameras, microphones, keys, digital recorders, monitors, speakers, VCRs, stereos, GPS devices and computer chips. In addition, introduction devices 104 could also be incorporated into stickers, labels, hangers, product stands or displays, product packaging, magazines, newspapers, books, pet tags and boxes.

In operation, the introduction device 104 needs to be loaded with one or more codes 106 that are associated with one or more sets of information present in the memory 102. This can be accomplished by activating the introduction device 104 (if necessary) and downloading one or more codes 106 that are stored in code memory system 150 through the memory system 101 output 152 and into the memory 108 of the introduction device 104. In another embodiment, this could also be accomplished by activating the introduction device 104 (if necessary) and downloading one or more codes 106 that are stored in the memory 102 through the output 152 and into the memory 108 of the introduction device 104. In either case, brief descriptions of the codes 106 and/or sets of information (such as a file names and/or other information, preferably that make it possible to identify the content of the related sets of information) associated with the downloaded codes 106 can be downloaded as well into the memory 108. In one variation, such descriptions are created and/or assigned by the first entity A. The introduction device 104 can gain access to the output 152 in a number of ways, such as via a hard wire connection or a wireless connection, and may utilize the internet or email to acquire the codes and such descriptions. In one variation, the introduction device 104 includes an interface for downloading codes 106 and any additional information to its memory 108. In another variation, the introduction device 104 includes an input for downloading codes 106 and any additional information to its memory 108. In other variations, the introduction device 104 is able to receive codes 106 and any additional information in its memory 108 directly or indirectly from the memory system 101 and/or from an internal receiver (not shown).

Before operation can begin, the introduction device 104 is activated. This can be accomplished in a number of ways. First, another device, like a phone, a PDA or a computer, could activate the introduction device 104 from afar. In other cases, like with a ring or jewelry, it could have on/off button that causes activation, or in some cases activation occurs when a send button is hit. In another embodiment, the introduction device 104 could be in sleep mode and just turn fully on when a signal is received and/or when a selector is pushed or turned on.

At this stage, one or more codes 106 can be sent from the introduction device 104 to a receiving device 110 that is associated with person B. Upon proper activation of the introduction device 104 (if necessary), in the preferred embodiment the introduction device 104 has a display 112 that displays a listing of codes 106 stored in the memory 108. The display 112 may also and/or instead display either the entire description or a brief description of the code 106 and/or set of information associated with each related code 106. From the list, person A activates a selection device 113, such as a keypad, dial, wheel, mouse, button or a touchscreen, or a combination of selection devices 113, to select one or more of the displayed descriptions and/or the displayed codes 106 for the related codes 106 and any related descriptions to be sent to receiving device 110. Upon making the selection, the selected codes 106 and any related descriptions are sent to transmitter 114 which in turn transmits the selected codes 106 and any related descriptions to the receiver 116 of the receiving device 110. While transmission of the codes 106 and any related descriptions between introduction device 104 and receiving device 110 can be accomplished via a hardwire connection, transmission is preferably accomplished in a wireless manner. Note that in one embodiment the introduction device 104 does not require any specific information identifying the receiver 116, the receiving device 110 or person B in order to successfully transmit the codes 106 and any related descriptions to the receiver 116. Also note that in some embodiments the introduction device 104 does not have a display 112, and instead the introduction device could indicate the codes 106 and/or descriptions of the codes 106 or the related sets of information on such device through a speaker (not shown). Also note that in some embodiments the introduction device 104 does not have a display 112 or a speaker, and instead the device could only store one or a very limited number of codes 106 and/or descriptions, which person A is able to distinguish (if more than one code) due to their sequence on the device or through an icon or symbol. For example, on a ring that is an introduction device 104 worn by person A, such device could store three codes 106 for transmission, and a portion of the ring could be twisted to align a selector line with a symbol for a house, representing a code related to a set of information containing personal information, and then there could be two other symbols which relate to codes 106 and/or sets of information selected by person A. In one embodiment, a receiving device 110 may request a code 106 relating to a certain classification or category of information by transmitting to the introduction device 104 a signal for such classification or category, and the introduction device 104 may then transmit a code 106 stored on the introduction device 104 that relates to a set of information of such classification or category. For example, person B may be interested in receiving codes 106 relating to sets of information containing coupons, which could be assigned a standard classification, and a signal for such standard classification could be sent by the receiving device 110 to an introduction device 104, and then such introduction device 104 that has codes 106 relating to such classification could automatically transmit such codes 106 to the receiving device 110.

The receiving device 110 can also include a transmitter 164 and a receiver 166 to send and receive signals, which may include wireless signals, such as BlueTooth signals, that may or may not be related to accessing the set of information stored in the memory 102.

The receiving device 110 can take on many forms. For example, it can be incorporated into any known devices that can receive signals containing information, such as cell phones, computers and PDA's. The receiving device 110 can be a stand alone device as well. The receiving device 110 can be portable as well. In particular, it can be in the form of jewelry worn by a person, such as a ring, watch, necklace, bracelet or a pin. In addition, a receiving device 110 can be incorporated into other devices, such as televisions, radios, satellite radios, cars, trucks, motorcycles or other vehicles, key fobs, CD players, DVD players, pens, pencils, non-cellular phones, ATM's, boats, subdermal implants, video cameras, nonvideo cameras, microphones, keys, digital recorders, monitors, speakers, VCRs, stereos, GPS devices and computer chips. In addition, receiving device 110 could also be incorporated into stickers, labels, hangers, product stands or displays, product packaging, magazines, newspapers, books, pet tags and boxes. The receiving device 110 and introduction device 104 can also function as an introduction device and a receiving device, respectively.

Upon receipt of the codes 106 and any related descriptions from introduction device 104, the receiver 116 transmits the codes 106 and any related descriptions to a memory 118 associated with the receiving device 110. Note that the codes 106 can be accompanied by any related descriptions that serve to identify the related codes and/or the related sets of information to person B.

In operation, the person B at any time can review any codes 106 and/or any related descriptions that have been transmitted to the receiving device 110 by person A or any other individual that uses a similar introduction device 104 to transmit codes 106 and any related descriptions. This is accomplished by activating a display system 120 that displays a listing of codes 106 stored in memory 118 and/or any related descriptions of the sets of information related to such codes 106, which can include a description of the content of the set of information, the name of the person that created the set of information, and/or the date or time the set of information was created, and/or any other information desired by person A or the party that created the code 106 and related set of information. From the list, person B activates a selection device 122, such as a keypad, dial, wheel, mouse, button or a touchscreen, or a combination of selection devices 122, to select one or more of the displayed descriptions and/or the displayed codes that relate to or are identical tothe codes 106 and any related descriptions to be sent to an input 154 of memory system 101 so as to gain access to the set of information associated with the selected codes and stored in memory 102.

Upon making the selection, the selected codes 106 and, in some embodiments, any related descriptions, are sent to transmitter 124 which in turn transmits the selected codes 106 and, in some embodiments, any related descriptions, to the input 154 of memory system 101. While transmission of the codes 106 and, in some embodiments, any related descriptions, between receiving device 110 and memory 102 can be accomplished via a hardwire connection, transmission is preferably accomplished in a wireless manner, and may utilize the internet or email to transmit the codes 106 and, in some embodiments, any related descriptions. Note that in some embodiments the receiving device 110, upon receipt of a code 106 (and, in some embodiments, any related descriptions), automatically transmits such code 106 and, in some embodiments, any related description, to the input 154 of memory system 101. Also note that in some embodiments the receiving device 110 does not have a display 112 and instead transmits all codes 106 and, in some embodiments, any related descriptions, in its memory 118 to the input 154 of memory system 101. In one embodiment, additional information is sent to the input 154 of memory system 101, which includes instructions on how and/or where the set of information associated with such code 106 is to be transmitted. For example, the receiving device 110 could transmit the code 106 to the input 154 of memory system 101 along with instructions to email the set of information related to such code 106 to person B's PDA, and the information could also include the related email address to which the set of information is to be sent. Then, the result would be that person B could receive a code 106 from an introduction device 104 on their receiving device 110, which could then automatically transmit through the transmitter 124 the code 106 to the input 154 of memory system 101, and the related set of information would be emailed to person B a moment later (as the additional information transmitted to the input 154 had directed).

Upon receiving the one or more codes 106 from the receiving device 110, the reading device 156 of memory system 101 reads the codes 106 and determines if the code 106 corresponds to a code 106 associated with a set of information present in such memory system. If it does not, then the code 106 is not acted upon. If it does, then the associated set of information is retrieved from memory 102 and transmitted according to instructions accompanying the transmission of the codes 106 from the receiving device 110. In one embodiment, the set of information is transmitted back to the receiver 116 of receiving device 110. Upon receipt of the set of information, the set of information is stored in memory 118. The set of information can then be sent from memory 118 to display system 120 where it is displayed to be reviewed by person B and/or sent to an audio output, such as speakers (not shown), for person B to listen to it.

Note that as a variation of the above mentioned process, additional information may be sent with the code 106 from the receiving device 110 to the input 154 and the reading device 156 of the memory system 101. In this case, the reading device 156 reads the instructions so that the set of information and/or code 106 is transmitted from the memory system 101 to a location per the instructions. The transmission may be through the internet, email or a phone call, or through another mass communication network or system.

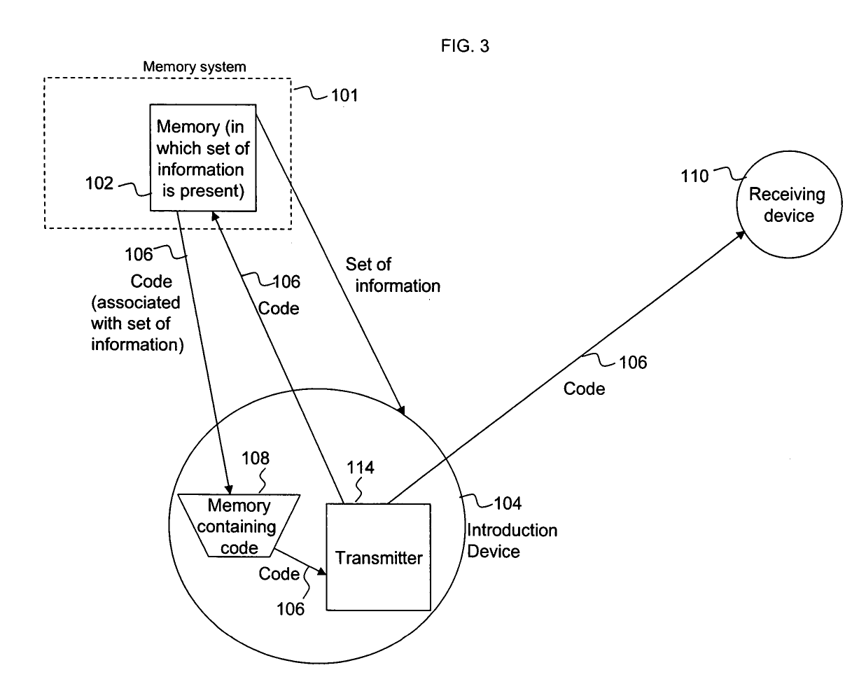

In the above example corresponding to FIGS. 1-2, a set of information stored in the memory system 101 of person A was transferred to person B after person A electronically sent person B a code 106 so as to gain access to the information. A variation of this process can be performed so that person A can gain access to the same set of information. In this case, the memory system 101, introduction device 104 and receiving device 110 are structurally the same as described above with respect to the embodiment of FIG. 2. However, as shown in FIG. 3, the introduction device 104 can transmit the stored code 106 to either or both the receiving device 110 and the memory system 101. In a manner similar to that described previously, the memory system 101 will send the set of information associated with the code 106 according to instructions accompanying the transmission of the code 106, which in this case instruct the memory system 101 to transmit the set of information to the device that sent the code 106, in this case introduction device 104. The set of information can be stored in memory 108 and displayed on display 112 in a manner similar to how person B displays the set of information described previously and/or the user could listen to the information (if audio) through an audio output, such as speakers. Thus, person A will have access to information that was originally stored offsite in memory system 101.

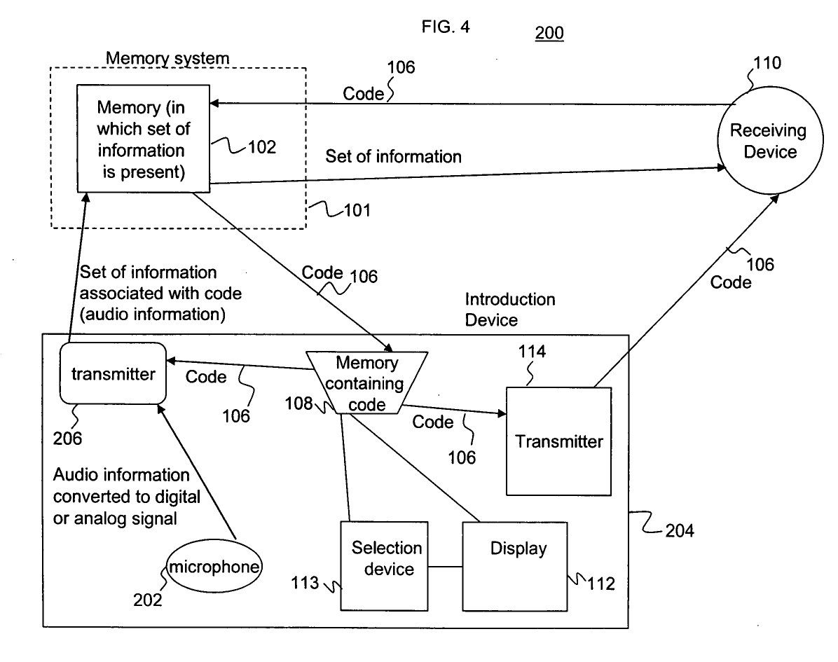

Another embodiment of an information access system is shown in FIG. 4. The information access system 200 includes a memory system 1110 and a receiving device 110 that are structurally the same as described above with respect to the embodiments of FIGS. 2-3. In this embodiment, the introduction device 104 of FIGS. 2-3 is modified so as to include a microphone 202 and a transmitter 204.

In operation, a person speaks into the microphone 202 so as to convey a message that contains a set of information. The message is then transmitted to the input 159 of the memory system 101 wherein the message/set of information is then sent to memory 102 to be stored. A code 106 is then associated with the stored message in the manner described previously with respect to the embodiment of FIGS. 1-3. Once the code 106 is then chosen for the message, person A can allow person B access to the message by sending the code 106 to person B's receiving device 110 via introduction device 204 in a manner similar to that described previously with respect to the introduction device 104 of FIG. 2.

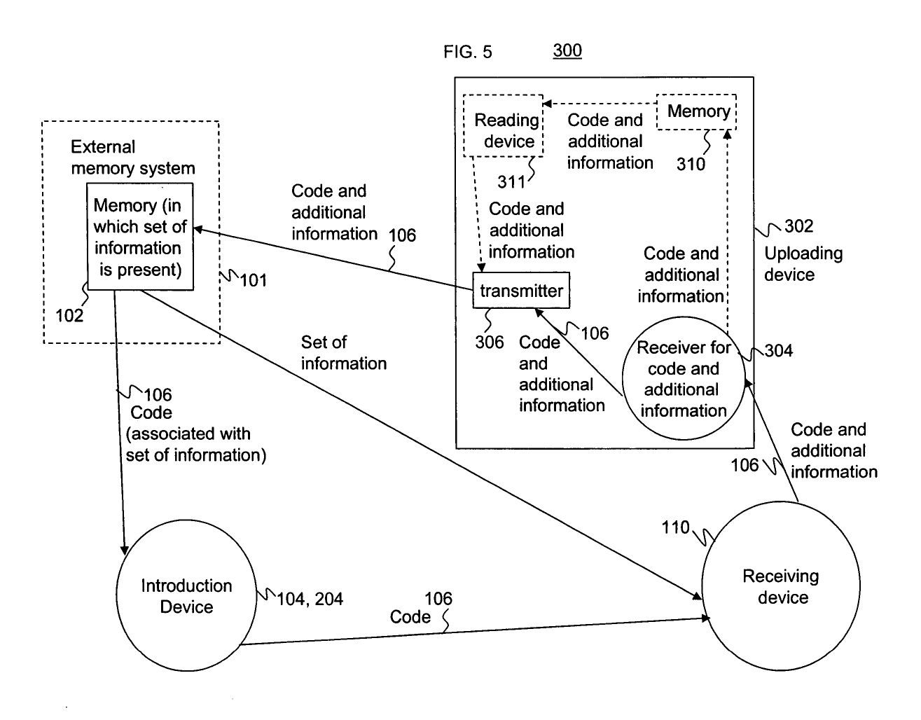

In the above examples corresponding to FIGS. 1-4, the code 106 was transmitted directly from the receiving device 110 to the memory system 101. It is possible to first send the code 106 to an externally located intermediary uploading device or system from which the code 106 is then sent to the memory system 101. For example, FIG. 5 shows an information access system 300 that includes a memory system 101, an introduction device 104, 204 and a receiving device 110 that are structurally the same as described above with respect to the embodiments of FIGS. 2-4. However, as shown in FIG. 5, the system 300 includes an uploading device 302 that is located externally of the introduction device 104, 204, the memory system 101 and the receiving device 110. The uploading device 302 receives the code 106 and additional information (for directing where the code 106 and/or the set of information is to be sent) from the transmitter 124 of the receiving device 110 after the code has been received and stored in receiving device 110 in the manner described previously with respect to the embodiments of FIGS. 2-4. As mentioned previously, the additional information contains information on where the code 106 and/or set of information is to be sent. This variation can be convenient when party B is in a location that the receiving device 110 cannot access the internet directly, for example, underground, or where reception is otherwise poor. In another variation, the set of information, instead of being transmitted directly to the receiving device 110 from the memory system 101, the set of information may first be transmitted to the uploading device 302 and then to the receiving device 110 and/or to another location as such aforementioned additional information directs. This variation is also useful for devices that may have a wireless transmitter for exchanging codes 106 but are not internet or email capable.

As shown in FIG. 5, the code 106 and the additional information are received by a receiver 304 of the uploading device 302 and then sent to a transmitter 306 which then sends the code 106 and the additional information to the input 154 of the memory system 101 so that the corresponding set of information can be accessed in the manner described previously with respect to FIG. 2. In another embodiment (dashed lines in FIG. 5), the receiver 304 is in communication with a memory 310 for storing the code 106 and additional information, which is in communication with a reading device 311 that reads such additional information, which is in communication with a transmitter 306 for sending the code 106 and/or set of information in accordance with the additional information.

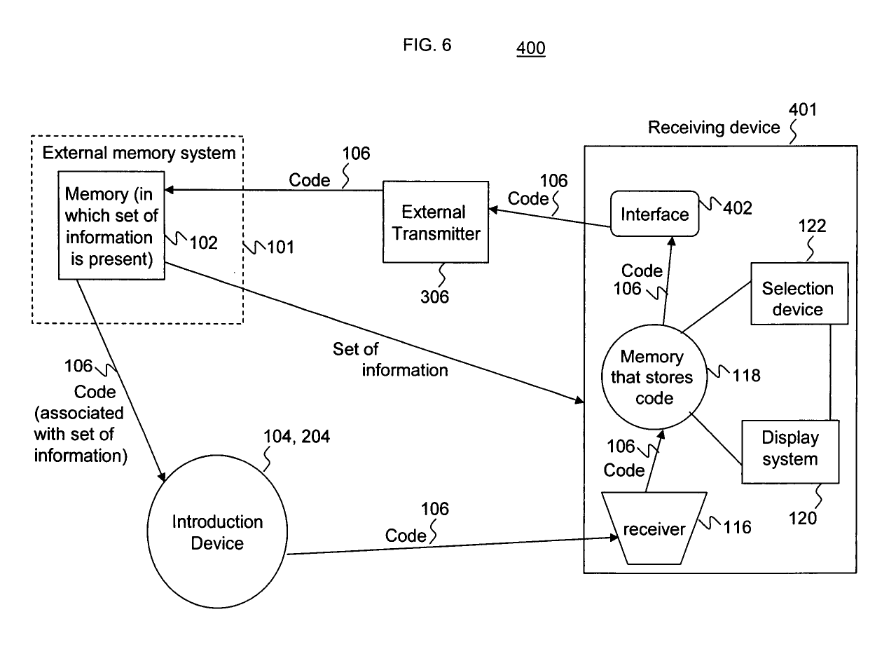

Note that another embodiment of an information access system 400 is shown in FIG. 6. The system 400 is similar to the system 300 of FIG. 5, wherein the receiver 304 can be omitted from the uploading device 302 of FIG. 5 and the transmitter 124 can be removed from the receiving device 110. The memory system 101 and the introduction device 104, 204 remain unchanged. In this embodiment, the code 106 is transmitted through an interface 402 of the receiving device 401 and on to the externally located transmitter 306. The code 106 is then transmitted to and processed by the memory system 101 in the same manner as described previously with respect to the embodiments of FIGS. 2 and 5. In another variation, the additional information mentioned above with respect to the embodiment of FIG. 5 can be sent to the transmitter 306 so as to transmit the code 106 and/or set of information to the proper location.

Another embodiment of an information access system wherein the code 106 is sent indirectly to the memory system 101 is shown in FIG. 7. In contrast with the embodiments of FIGS. 5 and 6, the set of information may be sent indirectly to the memory system 101. In particular, FIG. 7 shows an information access system 500 that includes a memory system 101, an introduction device 104, 204 and a receiving device 110 that are structurally the same as described above with respect to the embodiments of FIGS. 2-4. However, the system 500 includes an external server 502 that may be associated with the person B or a third party and is external to locations of persons A and B and the introduction and receiving devices. The external server 502 includes an online account 504 of person B.

A receiver 506 of the online account 504 receives the code 106 from the transmitter 124 of the receiving device 110 after the code has been received from memory system 101 and introduction device 104, 204 and stored in receiving device 110 in the manner described previously with respect to the embodiments of FIGS. 2-4. Besides the code 106, additional/delivery information containing information on where the related set of information and/or the code 106 is to be sent, such as online account 504, memory 102 and/or a device external to the memory 102 and the online account 504, may be sent with the code 106. Once the online account 504 receiver 506 has received the code 106 and any additional information, such code 106 is sent to a memory 508 that stores such code 106 and any additional information, and then if the online account 504 preferences and/or instructions received by the online account 504 with the code 106 so direct, the code 106 is then sent to transmitter 510 which in turn transmits the selected codes 106 and, in some embodiments, any related descriptions, to the input 154 of memory system 101. As mentioned previously, a destination for the set of information may be designated through the preferences established in the online account 504 and/or through instructions received by the online account 504 with the code 106. In another variation, the receiving device 110 transmits the code 106 directly to the memory system 101, but the memory system 101 then, pursuant to additional information directing where the information is to be sent (that had been sent to the memory system 101 with the code 106), transmits the related set of information to the online account 504, which then may subsequently transmit all or certain parts of the information to one or more devices and/or other destinations as directed in the online account 504 preferences and/or in any such additional information directing where the information is to be sent.

In one embodiment, the receiving device 110 transmits codes 106 and any related descriptions to an online account 504 of person B, which then in turn transmits such codes 106 to the input 154 of memory system 101. The online account 504 also transmits to the input 154 of memory system 101 instructions on how and/or where the set of information associated with such code 106 is to be transmitted, which may include instructions to transmit the set of information through the internet to the online account 504 of person B. In addition, the online account 504 could instead, upon accessing the set of information related to the code 106, copy and/or transmit the set of information to a location, such as the online account 504 memory 512 and/or a user device on its own without conveying any such instructions to the memory system 101. In either case, the set of information related to such code 106 is then transmitted through the internet to the online account 504 of person B, where the information can be stored in memory 512 and/or through output 514 viewed and/or forwarded to one or more computers or devices as specified in person B's preferences in its online account 504 and/or as directed by instructions received by the online account 504 with the code 106 from the person B's receiving device 110. The online account 504 could forward certain or all of the information received in the set of information to a device of person B or any other person through the internet, email or a phone call. The online account 504 allows person B a convenient way to manage his or her sets of information, both those that have been received from others as well as those that he or she has created themself, and/or to manage his or her codes and/or devices, as well as to establish preferences in the account establishing automatic protocols for forwarding information to certain devices, which can be contingent on classifications or categories of the sets of information, and/or the content and/or creator of the sets of information, and/or other factors selected by person B.

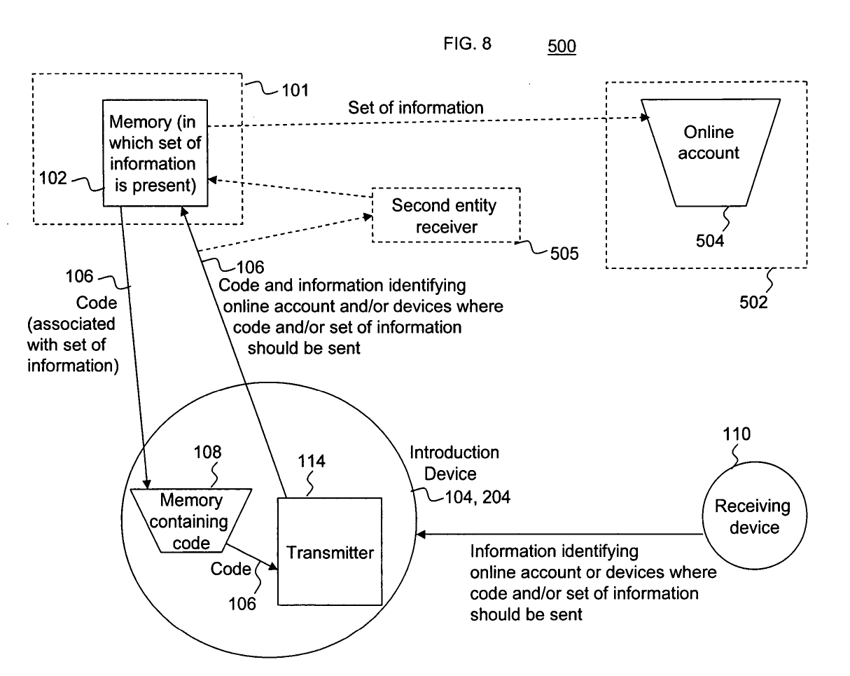

A first variation of using the information access system of FIG. 7 regards sending the code 106 from the transmitter 510 of the online account 504 to an external device or site 516 (dashed lines) which then sends (dashed lines) the code 106 to the memory system 101 where the code is processed in the same manner explained previously. In the alternative or in addition, the set of information from memory 102 can be sent by output 514 of the online account 500 to an external device or site 516 from where the set of information is sent to the online account 504 user's viewscreen or computer display or the receiving device 110 where the set of information is processed in the same manner explained previously. Note that the embodiments of FIGS. 1-14 contemplate sending the code 106, the additional information and/or the set of information to one or more intermediary devices or sites like item 516 during the sending of the information to the various components shown. A second variation of using the information access system of FIG. 7 is shown in FIG. 8. In this variation, the receiving device 110 is unable to transmit the code 106 to the receiver 506 of the online account 504 or to the memory system 101. In this situation, the transmitter 114 of the introduction device 104, 204 sends the additional information contained in the receiving device 110, regarding where the code 106 and/or the set of information is to be sent along with the code 106 to the memory system 101 (not to the receiving device as in FIGS. 2-4) and/or to the receiver 506 of an online account 504. This variation is useful when the receiving device 110 is a very simple device and allows the introduction device 104, 204 to transmit the code 106 on behalf of the receiving device 110 and for ultimate delivery of the set of information according to the receiving device's 110 instructions. In another variation, upon receiving a signal that is an attempt to transmit a code 106 to the receiving device 110, the receiving device 110 transmits the additional information regarding where the code 106 and/or the set of information is to be sent to the introduction device 104, 204, which then transmits such additional information along with the code 106 through the transmitter 114 to the memory system 101 (not to the receiving device as in FIGS. 2-4) and/or to the receiver 506 of an online account 504.

As shown in FIG. 8, the memory system 101 processes the code 106 and the additional information in the manner stated previously with respect to FIGS. 2-4 so that the set of information associated with the code 106 is sent to the online account 504 (which can be the online account 504 of the same party B to which the receiving device 110 belongs). As a result, party B can have a very simple device that a party A could use to transfer sets of information to party B. For example, a party B could place a very simple device on a car for sale at that business (a car dealership). A customer (party A) could come by and look at the car after the dealership was closed. If party A was interested in being contacted by a salesperson from the dealership with respect to that car, party A could select the code 106 containing their contact information and attempt to send that code 106 to the party B receiving device 110, which would then transmit back to the introduction device 104, 204 the additional information regarding where the set of information should be sent. The party A introduction device 104, 204 then transmits the code 106 and additional information to the memory system 101, which then sends the contact information to the online account 504 for the car dealership. The dealership could have operators standing by which could be able to see through the online account 504 which specific car the customer is interested in and the potential customer's contact information, and could immediately call the customer to discuss the details regarding the car's features. As a result, seconds after attempting to send the code 106 to the receiving device 110, the customer could receive a call from a salesperson and a business would then be able to capture sales opportunities which were previously lost and customers would enjoy greater convenience. In another variation the transmitter 114 of the introduction device 104, 204 sends the code 106 and, in one embodiment additional information, to a receiver 505 designated by party B in the additional information sent by or pulled from the receiving device 110. The receiver 505 then transmits the code 106 to the memory system 101 as the additional information directs and/or as party B has previously established with respect to the receiver 505.

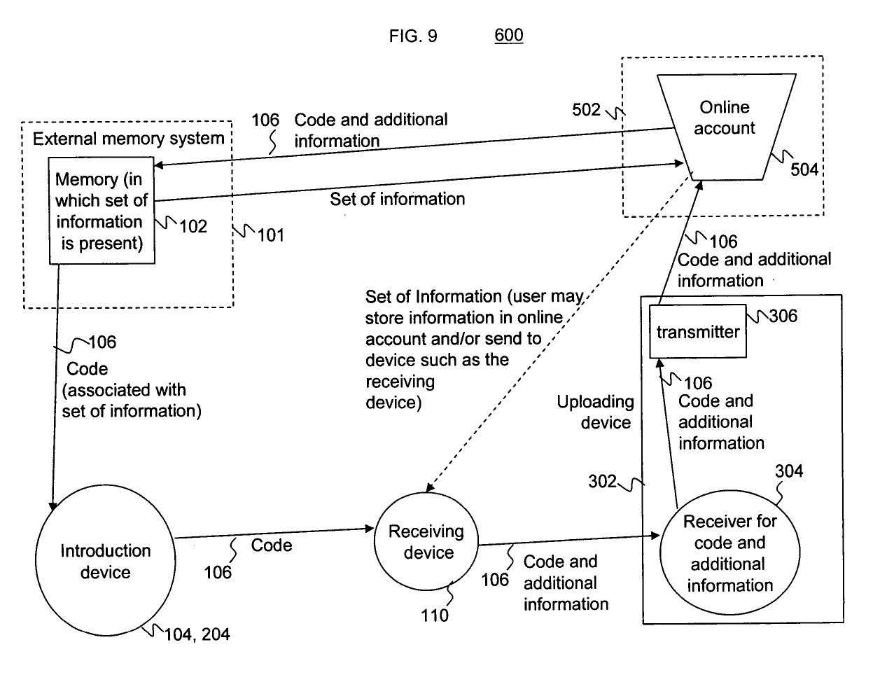

Another embodiment of an information access system is shown in FIG. 9. The information access system 600 includes a memory system 101, an introduction device 104, 204, a receiving device 110, an uploading device 302 and an external server 502 that are structurally the same as described above with respect to the embodiments of FIGS. 2-5, 7 and 8. In operation, the code 106 is generated in memory system 101 and transmitted to the introduction device 104, 204, receiving device 110 and the uploading device 302 in the same manner previously described with respect to the embodiment of FIG. 5. The transmitter 306 sends the code 106 and the additional information regarding where to send the code 106 and/or the set of information to the online account 504 of person B which then obtains the set of information from memory 102 in the same manner as described with the embodiment of FIG. 7. Once the online account 504 receives the set of information, it can be either stored in memory 512, and/or sent to receiving device 110 to be viewed on the receiving device 110 via display system 120 and/or listen to it through an audio output, such as speakers (not shown), and/or made available for the account user to view it on his or her display 112 or computer display and/or listen to it through an audio output, such as speakers, and/or otherwise transmitted as the online account 504 preferences and/or such additional information direct.

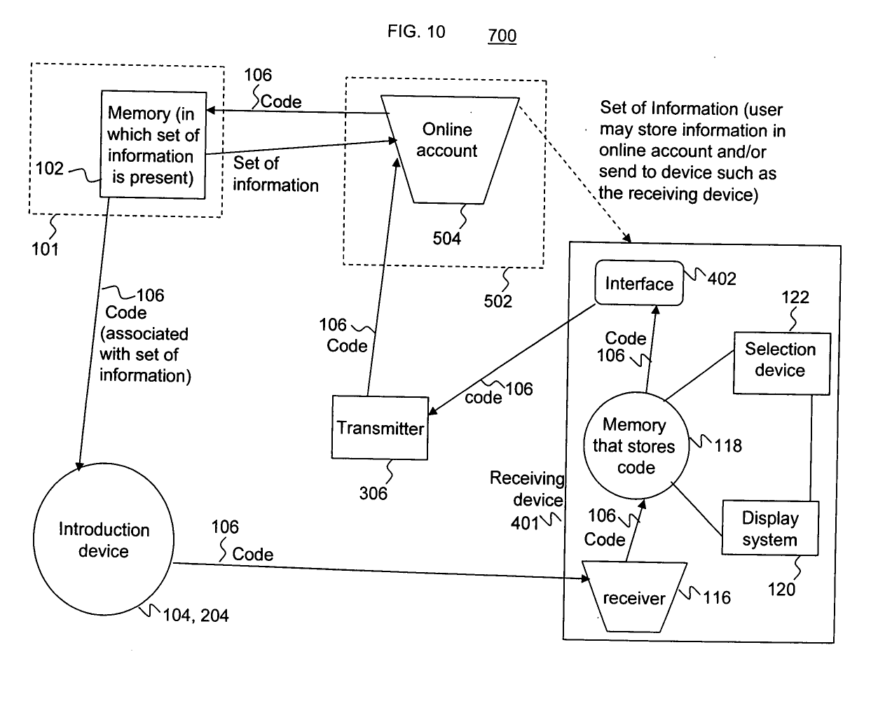

Note that another embodiment of an information access system is shown in FIG. 10. The system 700 is similar to the system 600 of FIG. 9, wherein the receiver 304 can be omitted from the uploading device 302 of FIG. 9 and the transmitter 124 can be removed from the receiving device 110. The memory system 101, the introduction device 104, 204 and the server 502 remain unchanged. In this embodiment, the code 106 is transmitted through an interface 402 of the receiving device 401 and on to the externally located transmitter 306 (such as described previously with respect to the embodiment of FIG. 6). The code 106 is then transmitted to and processed by the online account 504 in the same manner as described previously with respect to FIG. 9. In another variation, the additional information mentioned above with respect to the embodiment of FIG. 9 can be sent to the transmitter 306, the online account 504 and the memory system 101 so as to transmit the code 106 and/or the set of information to the proper location.

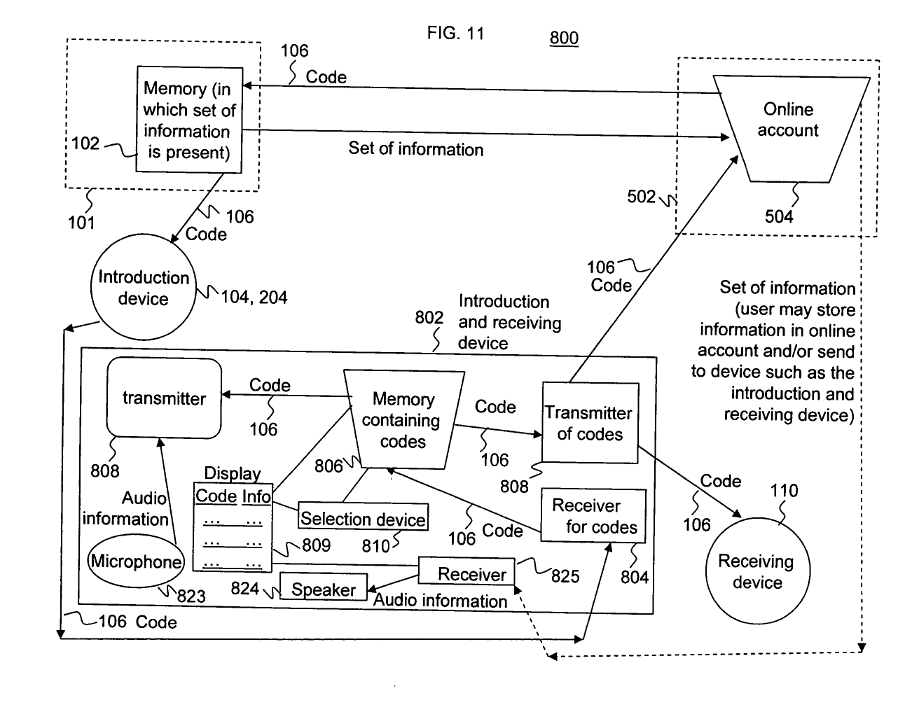

Another embodiment of an information access system is shown in FIG. 11. The information access system 800 includes a memory system 101, an introduction device 104, 204, a receiving device 110 and an external server 502 that are structurally the same as described above with respect to the embodiments of FIGS. 2-5 and 7-10. The information access system 800 further includes an introduction and receiving device 802 that can perform the combined functions of an introduction device 104, 204 and a receiving device 110. The introduction and receiving device 802 includes a memory 806, a transmitter 808 for sending codes 106 externally of such device to a receiving device 110 or to another introduction and receiving device 802, a transmitter 808 for sending information and/or codes to external memory systems 101, a receiver 804 for receiving codes 106 from an introduction device 104, 204 or another introduction and receiving device 802, a display 809 that displays a listing of codes 106 stored in the memory 806 and/or descriptions of the codes 106 and/or sets of information, and a selection device 810, to select one or more of the displayed descriptions and/or the displayed codes 106 and any related descriptions to be sent to receiving device 110. Display 809 and selection device 810 can be similar in structure as display 112 and selection device 113 mentioned previously.

In operation, the code 106 is generated in memory system 101 and transmitted to the introduction device 104, 204 in the same manner as described previously with respect to the embodiments of FIGS. 2-10. The code 106 is transmitted to a receiver 804 of introduction and receiving device 802 by transmitter 114 of the introduction device 104, 204. The code 106 is stored in memory 806 and sent to transmitter 808 which can send the code 106 to either or both the server 502 and, if person B desires to send the code 106 to another entity, to such entity's receiving device 110. If the code 106 is sent to person B's online account 504, the online account 504 of person B then obtains the set of information from memory 102 in the same manner as described with the embodiment of FIG. 7. Once the online account 504 receives the set of information, it can be either stored in memory 512, and/or sent to receiving device 110 to be viewed by the device 110 and/or it is made available for the account user to view it on his or her display 809 and/or listen to it through an audio output, such as speakers, and/or it is sent to the introduction and receiving device 802 to be stored in memory 806 to be later viewed on a display system similar to that of display system 120 and/or to be played through audio output of the introduction and receiving device 802, such as through speakers and/or the set of information can otherwise be transmitted as the online account 504 preferences and/or additional information (including instructions on where to send the set of information as discussed above) direct.

In a variation of the system 800, two transmitters 808 can be employed for introduction and receiving device 802 wherein one transmitter 808 is in communication with memory 806 and transmits code 106 to the server 502. The other transmitter 808 is also in communication with the memory 806 and transmits the code 106 to the receiving device 110.

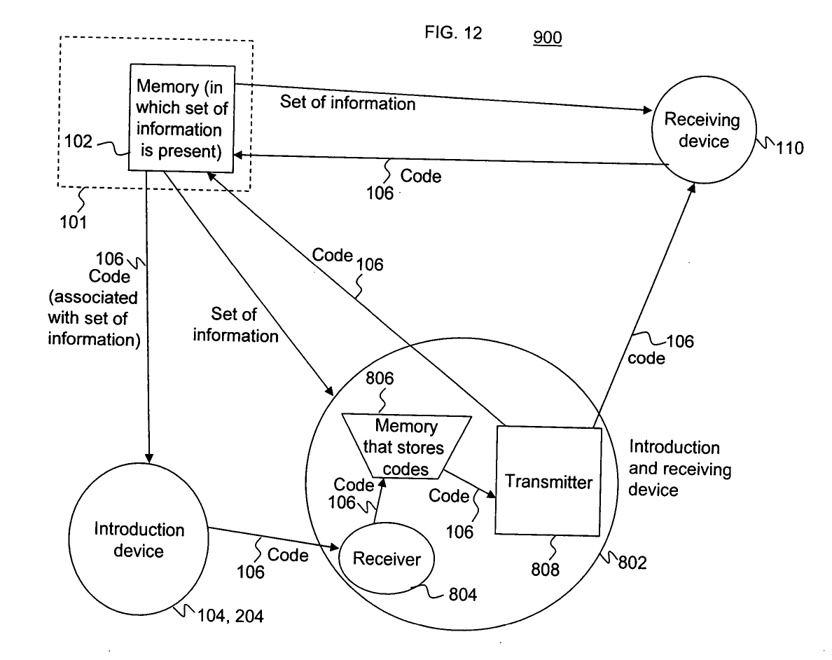

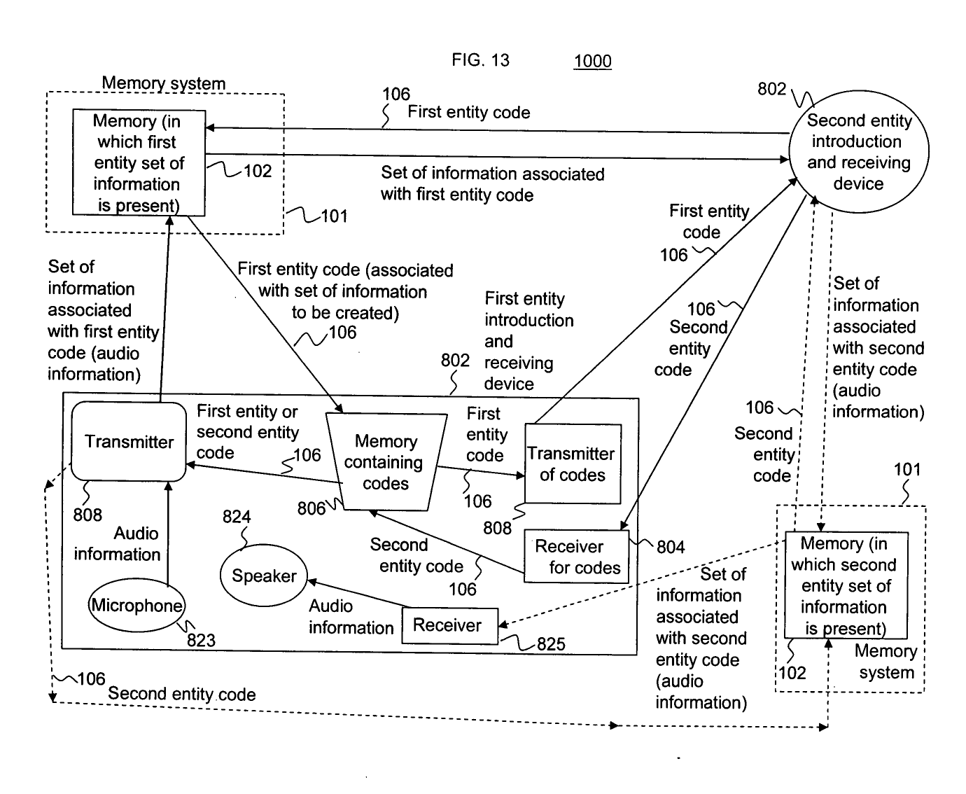

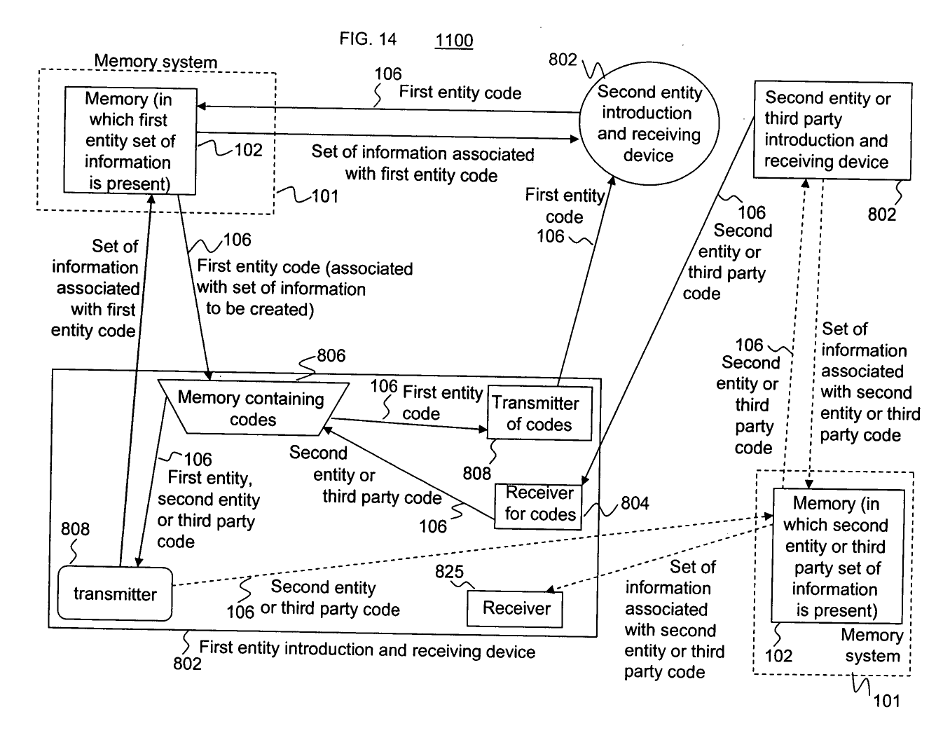

Another embodiment of an information access system is shown in FIG. 12. The information access system 900 includes a memory system 101, an introduction device 104, 204, a receiving device 110 and an introduction and receiving device 802 (as with previous drawings FIGS. 1-11 and subsequent drawings FIGS. 13-14, components of one or more of the elements of the system shown in FIG. 12 have been omitted purely for reasons of clarity) that are structurally the same as described above with respect to the embodiments of FIGS. 2-5 and 7-11.

In operation, the code 106 is generated in memory system 101 and transmitted to the introduction device 104, 204 and the introduction and receiving device 802 in the same manner as described previously with respect to the embodiment of FIG. 11. The code 106 is stored in memory 806 and sent to transmitter 808 which can send the code 106 to either or both the memory system 101 and, if person B desires to send the code 106 to another entity, to such entity's receiving device 110, which can then access the set of information as described with respect to FIG. 2. Following the introduction and receiving device's 802 transmission of the code 106 to the memory system 101, the set of information from memory 102 is then transmitted to the introduction and receiving device 802 to be stored in memory 806 to be later viewed on a display system of the introduction and receiving device 802 similar to that of display system 120 and/or to be played through audio output of the introduction and receiving device 802, such as through speakers 824.

FIG. 13 is an example of an information access system 1000 that includes a memory system 101, and two introduction and receiving devices 802 that are structurally the same as described above with respect to the embodiment of FIG. 12. In the first entity introduction/receiving device 802 in FIG. 13, this embodiment also includes a speaker 824 and a microphone 823, as well as a receiver 825 for receiving sets of information from external memory systems 101. In the variation in FIG. 13, the introduction and receiving device 802 demonstrates how an information access system 1000 could serve to facilitate two-way communication similar to a phone call. However, in this embodiment, there are two sets of audio information each associated with separate codes 106. In this embodiment the introduction and receiving device 802 is transmitting the set of information containing the words spoken by party A, and the same introduction and receiving device 802 is receiving the set of information containing the spoken words of party B. The advantages of this system include that party A can distribute a virtually unlimited number of codes 106 for audio communication similar to a phone number, without the hassle of obtaining a new phone number, and without the risk of loss of privacy or safety of giving out personal information, since party A could very easily delete the code 106 and no longer have any communication tie to the parties that had received that code 106. In addition, conference calls could easily be established at no additional cost to any of the parties involved. The codes 106 and related sets of information are transferred between the first entity introduction and receiving device 802 and the second entity introduction and receiving device 802 in the same manner that codes 106 and related sets of information are transferred between the introduction device 204 and the receiving device 110 as described above in FIG. 4.

FIG. 14 is an example of information access system 1100 that includes a memory system 101, a receiving device 110 and three introduction and receiving devices 802 that are structurally the same as described above with respect to the embodiment of FIG. 13. In the variation in FIG. 14, the first entity's introduction and receiving device 802 transmits a code 106 to a second entity's introduction and receiving device 802, and the code 106 is then transmitted to and processed by the memory system 101 in the same manner as described previously with respect to FIG. 13. In addition, the first entity's introduction and receiving device 802 receives a third-party code 106 from a third-party's introduction and receiving device 802, and such code 106 is then transmitted to and processed by the memory system 101 in which the set of information to which the third-party has access is present in the same manner as described previously with respect to the second entity's code and memory system in FIG. 13. In either case, the related sets of information are then transmitted from the respective memory systems 101 the same as in FIG. 2-13. The codes 106 and related sets of information are transferred between the first entity introduction and receiving device 802 and the second entity introduction and receiving device 802 and between the first entity introduction and receiving device 802 and the second entity or third party introduction and receiving device 802 in the same manner that codes 106 and related sets of information are transferred between the first entity introduction and receiving device 802 and the second entity introduction and receiving device 802 as described above in FIG. 13.

Each of the embodiments of Applicant's invention described with respect to FIGS. 1-14 allows a user to transfer various types of data from an offsite location to another party. Applicant's invention allows for the transfer of data that otherwise would be impossible for a device that does not have enough memory to store the data, such as video or audio data. In addition, Applicant's invention allows for the transfer of access to data in a very brief period of time that otherwise could take vast amounts of time to transfer directly. Furthermore, Applicant's invention allows for the transfer of data to persons and devices without any knowledge of the identity of such persons or devices required.

For example, a person could wave their PDA by a business associate's PDA and pass in a fraction of a second the code 106 associated with a video of a conference (which could be many gigabytes). Later, the business associate could connect his or her device to his or her computer, and in a split second, the code 106 would be uploaded to his or her online account 504. The online account 504 would then pull the video related to the code 106 from the memory system 102 into the person's online account 504 for him or her to view. This could be done so that at no time would there be any delay noticeable by the user necessary for “downloading” the entire video file.

Another example: A lawyer saves a file in his/her online account 504 containing his/her business contact information, his/her picture, his/her resume, and a document he/she recently published. A code 106 is created in the manner described previously and the lawyer downloads the code 106 to a ring that is an introduction device 104, 204. He/she then wears the ring at a conference and is able to pass his/her file of information to others at the conference without needing any information about them, simply by waving (if the introduction device 104, 204 is wireless, “waving” means bringing the ring within the wireless range of the receiving device 110, and if the introduction device 104, 204 is not wireless, “waving” means bringing the device in brief contact with the receiving device 110) his/her ring by the other person's ring, PDA, phone, or whatever device they have that can act as a receiving device 110. Then, moments later, a business contact could look at his/her internet or email capable PDA, and see the name, picture and the other file information created by the lawyer. No more trying to guess whom to match a business card up with.

Another example: A customer goes into a store and sees a TV on sale. The customer would like to buy the TV but needs to wait until a payday. The store wants to make sure the customer comes back to their store to buy the TV. The customer is able to wave their receiving device 110 by an introduction device 104, 204 placed by the TV by the store that includes a code 106 which includes in the related set of information a coupon on that TV good for $50 for the next two weeks. This is handy for the customer since all the information will be in the customer's online account 504 (details regarding the item to purchase, address of store, hours open, and the coupon) and the customer didn't even have to write anything down.

Another example: Expectant parents simply wave an introduction device 104, 204 by a neighbor's cellular phone that acts as a receiving device 110 to receive a code 106, and then 2 weeks later when the baby is born, and after pictures taken and saved by the parents as the set of information to be associated with the code 106 that they had previously transmitted, assuming the neighbor had uploaded the code 106 to their online account 504, the neighbor could then view the pictures in their online account 504.

The inventions embodied in FIGS. 1-14 can be adapted so as to be applied to many other real life situations. For example, a user receives a code 106 from a friend and selects to add the code 106 to those codes 106 that it could send to others immediately. The user can identify that code 106 and distinguish it from several other codes 106 on the introduction and receiving device 802 because of additional information that accompanies and describes the code 106 which serves as an “identifier” which the friend had given it, in this case called “Documents and media files regarding theme parks”. The user then selects such code 106 and sends it to a co-worker, but instead of passing it along wirelessly, the user touches the device to the co-worker's device and the transmission is sent through direct contact instead (this can be more secure since not transmitted wirelessly to any devices that may be in receiving range). A flashing red light on the user's receiving device 110 indicates that the code 106 is being transmitted. The code 106 is then received on the co-worker's receiving device 110, which sends back a transmission that serves as a “receipt”, which confirms to the user that the code 106 was successfully received by the co-worker. The user can tell that the receipt has been received by the flashing of a green light on his/her introduction and receiving device 802 (another light lights up when uploading to an online account 504). A record of the user receiving and sending the code 106 is recorded on the introduction and receiving device 802, and such information is sent to the user's online account 504. In some cases, data associated with the receiving device 110 (a “Device ID”) is also sent to and received by the introduction and receiving device 802, which then sends such information and Device ID information to the user's online account 504. This can be done to help keep a record of to whom codes 106 were transmitted and when.

In another example, a user sees a code 106 in an email which he saves onto his introduction and receiving device 802 as a code 106 to store (“Code 1”), and also sees another code 106 on a webpage that the user saves onto his introduction and receiving device 802 as a code 106 to store (“Code 2”), and also sees another code 106 in a document that the user saves onto his introduction and receiving device 802 as a code 106 to store (“Code 3”), and also sees a code in a newspaper that he types into the introduction and receiving device 802 as a code 106 to store (“Code 4”) and also receives a code 106 on his introduction and receiving device 802 through a wireless transmission from a friend's introduction and receiving device 802 that the user saves onto his introduction and receiving device 802 as a code 106 to store (“Code 5”). Some codes 106 can have identifiers which are names made for convenience (“Conv ID”), which can be names selected by a user as simply as a person selects a document name for saving on their hard drive. Other identifiers can be tied to a code 106 or serve as the code 106 (“Perm ID”), similar to web addresses, and can be passed along by just typing in the Perm ID, like typing in a cola brand name for example, without typing in the related code 106, or in some cases, such cola name could be the code 106. The user can now pass along Code 1, 2, 3, 4 or 5 in any manner it selects, which does not have to be the same way it received it.

In another example, at the checkout line in a grocery store, the user touches her introduction and receiving device 802 to an introduction and receiving device 802 at the checkout counter to transmit a code 106 to the grocer's introduction and receiving device 802 that relates to a set of information that contains information necessary to pay for the goods (although some merchants may request pin, signature, or additional items and/or information). In addition, the user also receives a code 106 on her introduction and receiving device 802 from the grocer's introduction and receiving device 802 that relates to a set of information that includes a detailed receipt regarding the purchased items and other purchase related information.

In another example, a user gives a friend $200 in cash. In exchange, the friend touches her introduction device 104, 204 to the user's receiving device 110 and transmits a code 106 tied to a set of information that contains information necessary to transfer $200 to a financial account of the user, which the user can later select when accessing his online account 504. In another variation, at the time the code 106 is transmitted to the user, the friend can select the exact amount of money to be transferred.

The embodiments of FIGS. 1-14 can be used so that a user can record a voicememo on his introduction device 104, 204 and on the introduction device 104, 204 the user can assign a code 106 to the voicememo, the code 106 for which had been saved onto the introduction device 104, 204 from a memory system 101 before the voicememo was even recorded (the code 106 was assigned to a set of information that was yet to be designated or created). The user then can wave his introduction device 104, 204 by a friend's receiving device 110 and sends the code 106 related to the voicememo. Once the user uploads the voicememo to the memory system 101, the friend could access the voicememo. In another example, if the introduction device 104, 204 is internet capable, the friend could access the voicememo following its creation and being designated to a code 106 and following the code being received by the friend's receiving device 110, for the friend could receive the voicememo in their online account 504 through the user's online account 504 which could access the voicememo stored in the user's introduction device 104, 204 and transmit the voicememo through such user's online account 504 to the friend's online account 504, even if the voicememo was not stored in the user's online account 504.

In another example, a video camera is waved by a monitor (both of which are internet capable), and the camera passes a code 106 to the monitor which contains in the related set of information the video data recorded on the camera which is then transmitted through the internet to the monitor, in real time. The same could be viewed in real time on any internet capable monitors around the world, as well as sent to remote recording devices. In addition, there would be the advantage of not being a need for any wires connecting the camera to any monitors, and as a result the space would be less cluttered and the camera could move freely.

Further variations of the information access systems of FIGS. 1-14 will be described hereafter.

For example the embodiments of FIGS. 1-14 where appropriate can be altered so that sets of information or files related to codes 106 can in some cases be changed and/or modified by any recipient of the related codes 106, and/or in some cases recipients of the related codes 106 can keep copies of the related sets of information or files, and/or in other cases the related sets of information or files can only be changed by certain parties.

Note that the embodiments of FIGS. 1-14 can be altered where appropriate so that users can use their online account 504 to organize and store their own data, even if distribution of codes 106 is not planned or a goal. Furthermore, an online account 504 can have many information access system receiving devices 110 that are set up to send codes 106 to it, and a receiving device 110 can be set up to send codes 106 to more than one online account 504. Furthermore, an online account 504 can also be set up for use by many users (an online account 504 either could or could not require logging in, and some cases could allow certain lists of users to have access, like members), where many users can upload codes 106 to, and/or modify files or sets of information, etc., like certain science fiction fans.

Note that the embodiments of FIGS. 1-14 can be altered where appropriate so that when a number of codes 106 are broadcast in a receiving device's 110 range simultaneously (for example some introduction devices 104, 204 can send several codes 106 simultaneously, and/or there may be several introduction devices 104, 204 broadcasting), a user can select which of such codes 106 that are then being or have recently been received to store on the receiving device 110. In order to assist a user in selecting codes 106 to store, some receiving devices 110 may display on a display 112 the codes 106 received most recently or with the strongest signal at the top of list, and/or codes received from certain Device ID's or through contact may be placed at the top of the list.

Note that the embodiments of FIGS. 1-14 can be altered where appropriate so that some introduction devices 104, 204 could send out codes 106 or selected codes 106 continually and/or automatically in predetermined intervals, and so that some receiving devices 110 automatically upload codes 106 to an online account 504 upon receipt, or automatically in predetermined intervals, or when selected, and if predetermined information related to codes 106 received is received in a user's online account 504, the online account 504 could transfer certain information to the user's receiving device 110 and/or otherwise as the user has indicated in the user's online account 504 and/or it could play music, vibrate or set off an alarm on the receiving device 110 to notify the user of the receipt of such information. For example, person A could transmit a code 106 relating to a set of information that indicates that person A is a member of a certain club, and then person B's receiving device 110 receives the code 106 and transmits it to his online account 504, which then accesses the set of information related to the code 106. If person B was also in the club, he could set up his online account 504 to transmit to his receiving device 110 the picture (if available) of person A if he is also in the club and/or other information about person A included in the set of information related to the code 106. Person B could also setup his online account 504 and/or receiving device 110 so that the receiving device 110 will play his club's theme song to let the user know that he just received the desired information about fellow clubmember person A who is standing nearby. Some devices with GPS could also relay the GPS coordinates of party A to help party B find him to introduce themselves. Some online accounts 504 could also be set up to let the person that had transmitted the code 106 to the user originally know that they had a successful find as well (so, with respect to the first example in this paragraph, person A could be notified of the match with person B) and the online account 504 could also send GPS, name, picture and/or other information of person B to person A.

In another example, a user can set up their online account 504 to include a dating profile and/or other profiles or other information that would include one or more pieces of information with which incoming sets of information are to be compared against. Certain types of sets of information could contain information that indicate that the set of information is of a certain type so that the set of information is compared against the proper information (for example, the set of information could include and/or be accompanied by a universal classification number, header and/or other identifier that the dating profile is also given by the user so that the information is compared against each other, and the classification could also help the user organize information by having information relating to certain classifications put in certain places in the account and/or handled in a certain manner (such as emailed to a user receiving device 110) depending on the classification). In the online account 504 dating profile and/or other profiles or other information there could be a certain number of factors and/or certain specific factors that could be preselected by the user to cause the online account 504 to signal a match to the user through a receiving device 110 or otherwise.

The preceding embodiments could also allow a person to find objects, products or services that he or she wants to buy (and/or buyers for objects, products and/or services that he or she wants to sell), for example a user could be notified that the person sitting next to them on the bus happens to be wanting to sell the very same antique car that he or she has been looking for.

In addition, an online account 504 or a third party program or service could let a user find people with certain factors and/or information in their online accounts 504 and/or see where certain people are located by looking at a map or similar screens, even if the user searching did not receive such users' codes 106. For example, the service could let a user search for people in his club by entering search terms (such as the club name) on an internet site and the service would then search a number of online accounts 504 to which the service has access and could then display on the user's screen the people in such club, their GPS locations and/or other information. The same approach could be utilized to search online accounts 504 containing any information desired, for example certain items and/or services that users may be offering to sell and/or buy. Some online accounts 504 could be made private or public at the option of the user, and/or certain information in a user's online account 504 could be made public while other information is made private.

Note that the embodiments of FIGS. 1-14 can be altered where appropriate so as to use certain additional signals and/or transmissions of data to and from devices (including between receiving devices 110 and towers that serve as introduction devices 104, 204) that would serve to restrict the codes 106 and/or sets of information that show up in a person's online account 504 and/or receiving device 110 and/or that are copied onto and/or remain on a receiving device 110 (whether designed to prevent spamming or to provide security, etc.). Such additional signals and/or transmissions of data could include random numbers, Device ID's, and/or one or more other assigned or random numbers, text, formulas, algorithms or symbols (or combinations thereof). For example, a user could set up his work receiving device's 110 online account 504 to only store codes 106 and sets of information from introduction devices 104, 204 that have Device ID's that are included on a list of all of the company's introduction devices' 104, 204 Device ID's, where such list is stored in the online account 504 of the user. This would prevent any spam on the user's receiving device 110.

The embodiments of FIGS. 1-14 can also be altered where appropriate so that introduction devices 104, 204 and/or receiving devices 110 have the option to “sense” other devices by detecting wireless signals sent by the other devices. Such introduction devices 104, 204 could be setup to then automatically transmit certain codes 106 when within range of certain other receiving devices 110.

Note that the embodiments of FIGS. 1-14 can be altered where appropriate so that a user will have the option of not importing in the user's online account 504 any or all codes 106 uploaded from his receiving device 110. Also, the user could select to import all codes 106 into the user's online account 504, but to not access the related sets of information until the user goes to the online account 504 and selects to do so. A user could select on their receiving device 110 and/or online account 504 to import some sets of information automatically but not all sets of information until selected to do so. For example, an online account 504 could be set up so that sets of information relating to codes 106 received from certain Device ID's would be accessed automatically, but for codes 106 received from introduction devices 104, 204 with other Device ID's (or where no Device ID was provided), the user wants to wait until they get home to review the codes 106 and/or related descriptions that he has received throughout the day to determine if he wants to access the related sets of information.

The embodiments of FIGS. 1-14 can be altered where appropriate so that the online account 504 software program can (but is not required) have customized data fields and/or folders so that when imported, certain types of information can automatically go into a user's designated sections in her online account 504 (for example, it could be based on the type of data, like pictures, or a designation given to the data, like for store receipts, and/or other factors and/or information). For example, the online account 504 could be set up so that email addresses would go in the contact information section for email addresses and/or pictures would automatically be put into a folder containing pictures. In another example, a store could send receipts of purchases with dollar totals, lists of items purchased, and name of store, coupons to encourage future shopping, etc., so that each populate proper predetermined fields, allowing for on online account 504 to more easily summarize information and list specific information (like total amount spent on gas (at any gas station), as well as amount spent at a specific gas station). Of course, online accounts 504 could also allow sets of information that could just go in “as is”, (for example, a page with information and pictures just kept as is). An online account 504 could provide a space that the user can just put in whatever information they want, which the online account 504 then could assign a code 106 to.

Note that the embodiments of FIGS. 1-14 can be altered where appropriate so that each device of the information access system could have to have a unique identifier, known as the Device ID, which could be tied with an online account 504. Note that a user could change the Device ID if they wanted to. Also a user could set up his online account 504 to only upload codes 106 from receiving devices 110 with certain Device ID's. A user could set up an online account 504 and/or certain receiving devices 110 so that many friends could send information to a single online account 504 so that other users can get the information even if they didn't personally upload the related code 106 to the online account 504. A user could have a number of Device ID's associated with a single online account 504, and/or could also have a single Device ID associated with a number of online accounts 504.

Note that the embodiments of FIGS. 1-14 can be altered where appropriate so that some information access system devices could allow the user to request that an email be emailed back to him with certain information and/or certain information be downloaded to his device at that time even if his online account 504 is normally isn't set to do so.

Note that the embodiments of FIGS. 1-14 can be altered where appropriate so that a set of information related to a code 106 could be made inaccessible to certain people that had received the related code 106 if the original user that assigned the code 106 and designated the set of information doesn't want such certain (but not all) people to have access anymore. For example, if those people don't pay a new monthly membership fee, their access to the related set or sets of information could be terminated by such original user. Similarly, for some codes 106, anyone could have access to modify the related set of information, while for other codes 106, only the original user or a limited list of people could modify the related set of information.

Note that the embodiments of FIGS. 1-1 4 can be altered where appropriate so that codes 106 with Conv ID's created by users could have some indicator that they are just names given by such user, like maybe italicized, underlined, be a different color, have a symbol at beginning or end, or otherwise be different in appearance and/or in some identifiable manner from Perm ID's in some way.

Note that the embodiments of FIGS. 1-14 can be altered where appropriate so that the user's online account 504 or another company could let users find/select/rent/lease/buy a Perm ID (a typable identifier or code 106 that they select) to rent/lease/use for a time period or to buy or to use for a certain number of uploads. For example, a user could type in word that they want in the Perm ID, like “Hawaii” and “Vacation” and the online account 504 or other company could provide available options to choose from, like “Hawaii Vacation 2005” or “HawaiiVaction17.” In one embodiment, the user or other persons could then type this Perm ID in as a code 106.

Note that the embodiments of FIGS. 1-14 can be altered where appropriate so that some information access system devices could have an option that allows a user to select on her receiving device 110, when or after she gets a code 106 from a user, where the set of information related to the code 106 should go in that user's online account 504. A user could pick the categories or locations in the online account 504 that could be possible and/or there could be default categories or locations in the online account 504 as well. Similarly, users could designate when accessing their online account 504 where the set of information related to a code 106 should go in their online account 504. In addition, an original user that created the set of information and assigned the code 106 could also designate a default category or location in a recipient's online account 504 where the set of information should go in such recipient's online account 504. Users could also select where the code 106 should be stored on the device if there are different folders or categories possible on that device. A person could pick the categories or folders possible and/or there could also be default categories or folders as well.

Note that the embodiments of FIGS. 1-14 can be altered where appropriate so that certain codes 106 and/or Device ID's are placed on a “blocked” list. An online account 504 and/or device could be set to delete the codes 106 that are on and/or related to Device ID's on such “blocked” list from such online accounts 504 and/or devices automatically and/or to send them to a specified location (like a spam folder).

Note that the embodiments of FIGS. 1-14 can be altered where appropriate so that when a user receives a code 106, the user can select (or can have the device set up to do so automatically) to have such code 106 added to a library and/or list in a user's online account 504 and/or in library and/or list of codes 106 on that device that the user could retransmit or email right away to another person. If the introduction device 104, 204 is internet or email capable, the user could also add the code 106 to the library and/or list of codes 106 on all devices of the user (or those that they select). For example, a user could receive a code 106 on a PDA, and it could also be added to the library of available codes 106 on the user's watch instantly.

Note that the embodiments of FIGS. 1-14 can be altered where appropriate so that a recipient of a code 106 relating to a set of information is able to limit the type of information that the recipient wants to receive and/or store in an online account 504 and/or on a device, for example, through selecting the types of information that they want to receive, like names only or contact information only, and/or through selecting the types of information that he does not want to receive, such as sets of information containing certain types of information, like adult materials. In addition, certain categories of codes 106 (for example, codes 106 that have been labeled and/or classified as advertisements by the user, the user's online account 504 service, a third party service, etc.) can be excluded from an online account 504 and/or device's list of codes 106 and/or the sets of information relating to such codes 106 could be set to not be accessed.

Note that the embodiments of FIGS. 1-14 can be altered where appropriate so that the code 106 could be transmitted through an audio or video or a physical signal (such as bumps) or any other type of signal that a device is capable of receiving. In addition, an introduction device 104, 204 and/or receiving device 110 may transmit and/or receive codes 106, respectively, through a: radio transmission, magnetic transmission, Bluetooth™ transmission, satellite transmission, infrared transmission, electrical transmission, bar code and optical reader (for receiving), phone line transmission, electromagnetic transmission, electromagnetic radiation, ultraviolet transmission, transmission consisting of electromagnetic field, and/or any other wireless transmission. In addition, an introduction device 104, 204 and/or receiving device 110 may transmit and/or receive codes 106, respectively, through a physical connection. In addition, other data can also be sent with the code 106, whether piggybacking on or with a code 106, or whether sent before or after the code 106 is sent, or whether sent to elicit or confirm sending of codes 106. For example, a code 106 is sent, but so is additional data including a description of the code 106 and/or set of information, any other identifier, Device ID, a password or encryption password or algorithm, a picture, time/date info, advertisement, delivery instructions or any other type of accompanying data. In another variation, the code 106 includes and/or is accompanied by such information that serves to describe the code 106 and/or related set of information to an entity.

The embodiments of FIGS. 1-14 can be altered where appropriate so that some information access devices could be set to not send Device ID's so that it could be untraceable as to who passed along codes 106. Furthermore, some information access devices could require a certain signal or transmission to be sent and/or received before sending and/or storing a code 106.

Note that the embodiments of FIGS. 1-14 can be altered where appropriate so that information access devices and/or online accounts 504 only accept codes 106 from certain users, online accounts 504 and/or Device IDs. For example, one could add all of a company's online accounts 504, users and/or Device ID's or all online accounts 504, users and/or Device ID's of the person's friends, etc. The receiving device 110 could store all codes 106 and then when the receiving device's 110 codes 106 are uploaded to the user's online account 504, only the permitted codes 106 would actually be stored in the online account 504, and only sets of information to such permitted codes 106 would be accessed and stored in the online account 504. In another variation, the information access receiving devices 110 would only store certain codes 106 (for example, if associated with permitted users, online accounts 504 and/or Device ID's), and would delete all others from the receiving device 110 itself and/or from the online account 504 (or those codes 106 would be sent to a specified folder).

Note that the embodiments of FIGS. 1-14 can be altered where appropriate so that a user could give a code 106 to a friend which would allow the friend to send a file back to the user, either at the time and/or in the future. For example, this could be done through the user passing along a code 106 relating to a set of information in the user's account that the friend could modify. Another variation would be where a user acquires a code 106 that has not been assigned to a set of information yet, and then reserves that code 106 for their future use, and in some cases, even attaches the description of what the related set of information will be. An example would be if a user gives a code 106 with a description of “Company Information” to a potential employer, and then the potential employer subsequently designates a file containing the company's hiring information to the code 106. The user would then be able to access the file containing the company's hiring information related to the code 106 once the potential employer has uploaded the file to the memory system 101.

Note that the embodiments of FIGS. 1-14 can be altered where appropriate so as to use a code 106 autoselect function for information access system devices, where the autoselect function is designed to have introduction devices 104, 204 transmit a code 106 relating to a certain type of information, which is of a type requested by a receiving device 110 through the transmission of a signal requesting such code 106. For example, a store could have a receiving device 110 that transmits a signal that requests a consumer's introduction device 104, 204 to autoselect the consumer's “consumer contact info” code 106, which the consumer's introduction device 104, 204 then transmits back to the store's receiving device 110. Another example is where a consumer has set her device to transmit a signal requesting the store's introduction device 104, 204 to autoselect and transmit any codes 106 relating to coupons that are available. Note that the embodiments of FIGS. 1-14 can be altered where appropriate so that codes 106 relating to information regarding products and/or services, as well as instant coupons can be sent to a user's receiving device 110 upon the customer's request.

In addition, the information access systems can be used to request and/or send advertising, wherein such advertising can be targeted based on codes 106 on a user's device and/or in an online account 504. For example, a store's introduction and receiving device 802 could access a customer's introduction device 104, 204 and/or receiving device 110 and upload all codes 106 or codes 106 of certain categories (for example, codes 106 relating to product information) on such customer's device, and then the sets of information related to the codes 106 could be analyzed and/or searched for products that such company sells, and then the company could transmit a code 106 to such customer's receiving device 110 that relates to an advertisement for such product and a special sale on the item. In another example, a user could create a set of information identifying items she would like to receive advertising for or information on, and a code 106 for such information (which could also be given a universal classification) could be sent to stores that the user enters, which the stores' receiving devices 110 would then receive and access the related set of information to see if the store has any of the related products. A user could also enter additional information relating to a product and/or coupon that would request that a store only send a code 106 if the store can meet certain thresholds selected by the user, for example, the user could request to only receive coupons of any sort and/or for specific items if the coupons are for 50% or more off of the standard price, or if the item is below a specific dollar amount.

In another variation, the user could receive on his receiving device 110 all codes 106 that the store transmits regarding its products, which the user's device then uploads to the user's online account 504, and then the online account 504 compares the sets of information related to all the codes 106 against certain information that the user has selected and/or entered for such store information to be compared against. For example, the user could enter in his online account 504 profile to be used for comparing against sets of information related to codes 106 received from stores, instructions for the online account 504 to retain any set of information that relates to a certain brand of a certain product, at a certain price (or range), within a certain geographic area, and/or based on other factors. The online account 504 could be setup to delete all of the codes 106 and/or set of information from the online account 504 and/or receiving devices 110 that did not result in desired matches.

In addition, a user could set up her receiving device 110 to only display on its screen codes 106 that have first been uploaded to the user's online account 504 and compared against certain profiles, preferences, factors, lists and/or filters, so that the receiving device 110 only displays codes 106 of a desired nature, with no (or little) spam. In addition, a user could set up her receiving device 110 to only display on its screen codes 106 that have first been compared against certain profiles, preferences, factors, lists and/or filters that are stored on and/or accessible through the internet on the receiving device 110, so that the receiving device 110 only displays codes 106 of a desired nature, with no (or little) spam.

The embodiments of FIGS. 1-14 can be altered where appropriate so that the number of times a code 106 can be used is limited, such as a code 106 to be used to purchase an item and/or a service. For extra security regarding sensitive items like personal finances, entry of a PIN may be required before a code 106 would be accepted.

Note that the embodiments of FIGS. 1-14 can be altered where appropriate so that in the case of purchasing products and/or services, confirmation of the code 106 can be generated. For example, if a person transmits a code 106 to be used for a purchase, then the company could submit the code 106 through the internet to the related user's online account 504 and/or a third party, which could then send back (in addition to other information) a multi-digit numeric/alpha or alphanumeric code and/or other information that could appear on a display of the merchant which the user could compare against the multi digit numeric/alpha or alphanumeric code or other information on the user's device's screen (could have been loaded onto the device when the code 106 was). Once such confirmation and/or other information providing confirmation is received by the merchant, the user could also be required to input a multi number/alpha or alpha numeric code and/or other information into a keypad or touchscreen at a merchant and/or on a device to send to the merchant, and then the merchant could use information related to the code 106 for payment of the product and/or service. The preceding would make the customer sure that the merchant did in fact get the code 106. If the merchant did not show the right code 106 or related information on their screen, then the user could not submit the final “clear to submit” code or information that is specific to that purchase. In addition, a merchant could also receive a picture of the person and/or a fingerprint and/or eye scan and/or other biometric data through the information related to the code 106 or another user code 106, which the merchant could use to confirm the identity of the user purchasing the product and/or service. Such identifying information could be related to a special User ID code. The information related to a code 106 could contain a conventional credit card or charge card account number (or checking account number, savings account number or similar financial account or credit account number) and related information (like a “good through” date), as well as additional information identifying the user which could simplify the process for customers since he could not have to carry identification or other items (everything could be done through their phone), while the merchant also gets added security (since identification information related to a code 106 could be provided and/or assured through a third party service) and convenience. In addition, an online account 504 and/or other service could ask a user to confirm in real time if a financial transaction is permitted, the amount to be paid and/or received, and/or any other information.

If the code 106 and/or information which had been entered by the customer and the code 106 and/or information sent from the online account 504 and/or third party to the merchant were not followed by a final consumer or supplemental code 106 or PIN, etc., within a certain period of time, for example 10 minutes, the code 106 could then be set to be automatically invalidated and therefore couldn't be used.

Note that the embodiments of FIGS. 1-14 can be altered where appropriate so that the name of the user and/or other user information could be supplied with and/or contained in the code 106 and/or set of information related to the code 106, so the user's name would appear on the merchant's computer. In the case of dealing with a merchant, the identifying information could be put in by the online account 504 service or possessed and/or provided by a third party as a separate code 106 or part of information associated with a code 106, so a customer could not change such information.

Note that the embodiments of FIGS. 1-14 can be altered where appropriate so that the user could perform financial transactions anonymously (for gifts, donations, etc.). For example, the user could make a purchase, deposit and/or transfer money into a special online account 504 or other financial account wherein a person gains access by just using the code 106 and through which the money is transferred into the user's online account 504 or other financial account or as he or she specifies or could be cashed out at ATMs, stores, etc.

Note that the embodiments of FIGS. 1-14 can be altered where appropriate so that a user could purchase a code 106 by inserting cash (or using credit card, etc.) at special ATMs, through online accounts 504, or at businesses that let a user buy the codes 106 that are associated with a set of information of certain financial value to the user. The purchase can be confirmed and the code 106 can be used at a later time.

Note that the embodiments of FIGS. 1-14 can be altered where appropriate so that a person can transmit a code 106 to a specially designed ATM so that a certain amount of cash is dispensed in an anonymous manner.

Note that the embodiments of FIGS. 1-14 can be altered where appropriate so that if a person loses an information access system device or is worried about an online account 504 or codes 106 being accessed or stolen, etc., the user could contact an appropriate entity to have all or some codes 106 canceled and/or the online account 504 access frozen. In addition, if an information access system device is stolen or lost it can be locked down (possibly for a fee) so that it could not upload and/or download codes 106 and/or transmit codes 106 to other persons or devices.

In addition, the user could send a panic code 106 which would indicate who the person was, etc., and the location of where the code 106 was sent from could be determined by police through the Device ID of the receiving device 110 in many cases, and/or through a related GPS device or phone tracking, etc. of the user's introduction device 104, 204. Such code 106 either could be sent from the user's introduction device 104, 204 or through another receiving device 110 and then to a special online account 504 of the police. Another similar example is used by a user of a code 106 that is stored in an introduction device 104, 204 that could allow persons other than or in addition to the police to track people and/or objects. Not only could the introduction device 104, 204 and code 106 help a user and/or police track a person and/or an object, if the device is also a receiving device 110, the user and/or police could also even view (see a still or video image) a criminal that is stealing the object and/or kidnapping the person because the receiving device could receive codes 106 relating to cameras placed throughout the city and/or stores, for example, for which the set of information related to the code 106 could be photos taken on such cameras. For example, if a child with an introduction and receiving device 802 was kidnapped, the device could pick up images from security cameras throughout the mall where the child was abducted (which authorities would currently be able to know in many situations to look at) as well as in a gas station 100 miles away (which authorities would currently not know to check unless they received a tip) where the kidnapper stopped for gas. Such images could include the car and license plate of the criminal which could result in the prompt safe return of the child. In addition, this information access system also provides the advantage that a user and/or police could view all of the relevant security camera videos and images in moments through an online account 504, rather than having to take hours visiting the different locations to view security camera recordings. Another example is a receiving device 110 on an expensive jacket in a store, which a shoplifter takes out through the entrance. The receiving device 110 receives a code 106 related to a picture of the shoplifter taken the moment the shoplifter walks by the camera. The store is able to see on the computer in their store that the expensive jacket has been stolen and could then see the picture of the shoplifter taken moments before. The online account 504 also lists other cameras and introduction devices 104, 204 that the shoplifter has walked by on their way out of the store which has made it easy to track where the shoplifter is going. The store could then transmit to mall security and/or police the image of the shoplifter and if the expensive jacket device is also an introduction device 104, 204, a mall security office could go to the exit which the shoplifter just left (which could be determined through the online account 504) and then when the officer approaches the suspect, they could approach the suspect and look at a receiving device 110 of the officer to see if, as he approaches a close range around the shoplifter, whether his receiving device 110 receives a code 106 that identifies the jacket and the store, for example. This would allow an officer to be sure that the suspect actually had the item, even if the item was concealed, which would reduce litigation against false accusations and also decrease shoplifting. In addition, should the store decide to prosecute, they will have pictures and images to use for prosecution that would be easily accessible in their online account 504 and would not require the store to incur additional expenses for time looking at hours of footage of numerous mall cameras to try to see if the suspect can be seen on those tapes.

Note that the embodiments of FIGS. 1-14 can be altered where appropriate so that computers and/or other devices can also be programmed to request certain codes 106 at certain times.

Note that the embodiments of FIGS. 1-14 can be altered where appropriate so that computers could also track production and/or update inventory, etc., through continually updating sets of such information related to codes 106.

The embodiments of FIGS. 1-14 can be altered where appropriate so that a universal “upload” code 106, signal or transmission sent to an information access system device would cause it to transmit all codes 106 in its stored memory, in some cases along with the Device ID, and in some cases along with information directing the online account 504 and/or device to which the codes 106 and/or the related sets of information should be sent.

Note that the embodiments of FIGS. 1-14 can be altered where appropriate so that a user could have the option of only uploading the code 106 and/or set of information by contact (not wireless) or by wireless (not contact), and/or if they hit a button or otherwise select to permit uploading for next preset or default period of time.

The embodiments of FIGS. 1-14 can be altered where appropriate so that a user could have receiving devices 110 set up to only accept a unique code 106, signal or transmission for uploading, so for example, a home computer is the only device to which the codes 106 on the receiving device 110 could be uploaded. Furthermore, the information access system device or computer could automatically connect (or if user wants, could require permission prior to connecting) to the user's online account 504 and upload codes 106 received to such user's online account 504.

Note that the embodiments of FIGS. 1-14 can be altered where appropriate so that computers and/or devices are setup, managed and/or designed so that people could be confident that copying of the codes 106 upon uploading to such a computer and/or device won't occur.

Note that the embodiments of FIGS. 1-14 can be altered where appropriate so that a user could select an option(s) that sends an additional instruction(s) to an online account 504 that instructs that a set of information related to a code 106 (or maybe to certain select codes 106 identified by user) be sent to one or more information access system devices (either the default device in a profile or preferences or those that the user selects at the time) and/or email addresses, rather than always having such set of information sent to devices and/or email addresses. This would allow users to only get emails and/or sets of information on a device when they choose.

Note that the embodiments of FIGS. 1-14 can be altered where appropriate so that they can be used for specialized targeted advertising based on, for example, places the user and/or information access system device has been (for example, if a store determines that a user looked at a certain product at another business, the store may want to target the user with an advertisement for the same product at a lower price), other code 106 recipients the user has sent codes 106 to and/or received codes 106 from (which the store could tell by the Device ID's stored in the device), content of sets of information on the device and/or in the user's online account 504, other codes 106 on a device and/or in user's online account 504, a combination thereof and/or on other factors.

Note that the embodiments of FIGS. 1-14 can be altered where appropriate so that a user could receive a code 106 on a receiving device 110 for a product at a store and the best price of that item and/or nearest location where it is available as found through an internet search and/or through prices and/or programs promoted through an online account 504 and/or third party companies could be found and put in the user's online account 504 and/or emailed to them and/or sent to an information access system device. Same could be done if user just sees the item online and enters the code 106 in. In addition, a company could pay $1 million per year (for example) to an online company to have all of their items' prices checked to see if cheapest and then, if so, included in user's online account 504.

Note that the embodiments of FIGS. 1-14 can be altered where appropriate so that the user could click on the code 106, a code 106 identifier (Conv IV or Perm ID), or a related description or other accompanying content (symbols, thumbnail image, text, etc.) and the device and/or online account 504 would bring up the related set of information (which, if currently on a webpage, could either open in place of such existing page, or in a new window on the same page or could go to it as a new webpage).

The embodiments of FIGS. 1-14 can be altered where appropriate so that for secure data and/or for membership situations for example, receipt of the code 106 alone is not sufficient to access the related set of information. In this case, the related set of information can only be viewed if a proper login (providing password, and/or meeting other requirements and/or performing other tasks, etc.) is performed and/or are using and/or associated with a permitted online account 504, Device ID and/or are a permitted user. That way a user could control and/or limit who could view and/or otherwise access a set of information related to a code 106. In another variation, a user could allow some parts of or portion of a set of information to be viewed without another user first logging in.

Note that the embodiments of FIGS. 1-14 can be altered where appropriate so that some sets of information can be tied to information not saved in every code 106 recipient's online account 504, so such online account 504 is always refreshed with current data. For example, a code 106 could be tied to the current weather in Honolulu, and wherein only a certain weather service could alter the set of information related to that code 106.

Note that the embodiments of FIGS. 1-14 can be altered where appropriate so that some information access system devices are designed to send the Device ID, and/or other information identifying the online account 504 to which the codes 106 are to be sent, along with the codes 106 (and any other related desired information, like transmission receipts, time/date of codes 106 sent/received, etc.) in a “bundle” in a manner that the bundle could be passed along to other devices for uploading by such other devices to the online account 504 identified in such information and/or tied to the original Device ID included in the bundle.

The embodiments of FIGS. 1-14 can be altered where appropriate so that some computers or information access system devices could upload codes 106 for any devices, like ATM-types, but others could be set up to only allow devices that have been set to upload to it specifically to upload to it (for example, if a user didn't want his phone to be a conduit for anyone else's codes 106).

Note that the embodiments of FIGS. 1-14 can be altered where appropriate so that the online account 504 could send a signal back to information access devices to let them know a certain bundle has been received so that such devices don't keep trying to send such bundle.

Note that the embodiments of FIGS. 1-14 can be altered where appropriate so that some information access system devices could be set up so that if the code 106 is sent to a friend's receiving device 110, but the friend's receiving device 110 is not internet capable, then the friend could upload the bundle right back to the user's introduction device 104, 204 which sends the bundle to the receiving device 110 user's online account 504. Some receiving devices 110 could store data that indicates the receiving device 110 is not internet capable, in which case the user's introduction device 104, 204 could automatically send the friend's receiving device's 110 Device ID, and/or other information identifying the online account 504 to which the codes 106 are to be sent, and the codes 106 as a bundle (along with any other bundles) to receiving device 110 user's online account 504 (without steps of sending to friend and friend sending back as a bundle needing forwarding) in addition to or instead of sending the code 106 to the friend's receiving device 110

The embodiments of FIGS. 1-14 can be altered where appropriate so that when a set of information is received by a user that requires software to view, use, access, etc., any such information and the user doesn't own or otherwise have access to the software, that an online account 504 service and/or third party could grant access to such software for free (if legally permitted) or for a fee and/or otherwise make it available to user (including through third parties). In other cases, a user may be able to use software on their computer and/or other devices to view, use, access, etc., any such information in the online account 504 and/or on their device.

Each of the embodiments of Applicant's invention described with respect to FIGS. 1-14 allows a user to transfer various types of data from an offsite location to another party. Another example would be a user transmitting codes 106 wirelessly and continuously or periodically from their introduction device 104, 204, where the related set of information consists of mini-videos the user has made of themselves. This would add a whole new level to people watching.

Another example is that users could use the information access system devices for person-to-car, person-to-person, etc., communications. For example, an introduction device 104, 204 integrated into a car sends out a code 106, which could have an identifier/description that would allow a bystander to visually identify the related car, for example “red sports car, Virginia plates”. Then a car nearby that receives the code 106 that was being transmitted wirelessly by the first car, would show up as currently receiving that code 106 on the receiving device 110 integrated into their car. Then the user in the second car could “call” the user in the first car by either accessing the set of information related to the first car's code 106 and then speaking into the receiving device. In one variation, the set of information would be set up so that multiple users could “create” information (by speaking into their receiving device's 100 microphone 123, for example) and the second user need only speak for his voice to be added to the set of information related to the code 106. The first car user's online account 504 could be set up to notify that first car user that someone is accessing that set of information (trying to contact them) related to that code 106, and the online account 504 could be set up to instruct one or more devices of the user that someone is trying to contact them, for example by having the user's device ring, vibrate, play an audio file, flash or otherwise indicate to the user in some fashion. The users could then communicate through text, video, and/or audio, and otherwise talk or communicate as discussed above. This communication method could keep kids entertained while traveling. It could also make it easier to ask directions (and safer, since no pulling up and rolling your window down near strangers in neighborhoods that you don't know). It could also make it easy to pass time. The preceding could be used to initiate any kind of real time communication just by transferring codes 106 and without requiring knowledge of a recipient's identity and/or any specific information about them. Of course the system could also be used to communicate with those that they do know as well. In another variation of the preceding, the first car's set of information related to the code 106 could just be a set of information that the first car user could modify, which would allow the second car user to hear, for example, information said by the first car user, but would require the first car user to also access a similar set of information relating to a code 106 of the second car user in order for the first car user to hear, for example, what the second car user is saying. The preceding could also be done with introduction devices 104, 204 and receiving devices 110 that are not integrated in cars as well, such as PDAs, watches, etc. In order to facilitate communication with those nearby, and/or to otherwise highlight codes 106 on receiving devices 110 that are being and/or have recently been transmitted by nearby introduction devices 104, 204, the receiving devices 110 could indicate and/or highlight such codes 106 by placing them at the top of a list of codes 106 received and/or in a special folder and/or otherwise be marked and/or displayed on such receiving devices 110. In addition, the online account 504 and/or introduction device 104, 204 and/or receiving device 110 could store a copy of a call and/or communication through such devices and/or online account 504 and could designate a unique code 106 to each such recording. In addition, a user could cause an online account 504, or it could be set to automatically, send a signal to an introduction device 104, 204 and/or receiving device 110 notifying such other user that the user is trying to contact them. Another advantage of using the codes 106 for communication is that, in one variation, the user could easily delete the code 106 that is used for communication with the certain entities that the code 106 was given to, thereby terminating future communications with such entities through such code 106.

An online account 504 can be set to send a transmission to a receiving device 110 and/or introduction device 104, 204 that causes such device to notify the user (through an alarm, light, vibration, playing audio, and/or in some other manner) that a set of information related to a code 106 has been accessed and/or that a set of information has been modified, either at all, or within predetermined extent, and/or that a set of information received includes predetermined information.

Another example is a wrist band that patients wear at hospitals. The wristband could store a code 106 that is a “medical code” that relates to a set of information prepared by hospitals, doctors and/or other medical professionals and/or support personnel, and which could be continually updated. The related set of information could include standardized fields for specific types of information, such as x-rays, medical history, etc., including insurance information. This would provide the advantage of easy access to information that is always up to date. Hospital and emergency personnel could get needed information instantly regarding patients. Special logins or computers could be required for access to the information related to the codes 106. In addition, the codes 106 could relate to information on a custom secure system in order to prevent unauthorized access to confidential information. Of course, the medical code could also be stored in any type of introduction device 104, 204.

Another example would be that a user could have a set of information related to a code 106 that includes a program and/or algorithm, which such user uses to process data and/or information contained in other sets of information relating to other codes 106 that the user obtains, and/or for use by others upon their receipt of the user's code 106, for their use in processing their data and/or information through. In addition, the user could have a set of information related to a code 106 that includes input and/or data for a program and/or algorithm, which the user desires to be processed through such a program and/or algorithm contained in a set of information relating to another code 106 that the user obtains, and/or for use by others upon their receipt of the user's code 106 for their use in processing in their program and/or algorithm.

A receiving device 110 could store in its memory 118 each online account 504 to which it is to upload codes 106 received on such device. In addition, the receiving device 110 could just store one online account 504 of the user to which it is to upload codes 106 received on such device, and then that online account 504 could forward codes 106 and/or related sets of information on to other online accounts 504 and/or introduction devices 104, 204 and/or receiving devices 110 as the online account 504 user had setup in his online account 504 options and/or preferences. In addition, an online account 504 could forward codes 106 and/or related sets of information on to other online accounts 504 and/or introduction devices 104, 204 and/or receiving devices 110 based upon the Device ID and/or other information included in the transmission of the codes 106 to such user's online account 504. In addition, codes 106 could be routed to online accounts 504 by such receiving devices 110 first sending codes 106 and the Device ID's of such receiving devices 110 to an internet destination that then forwards the codes 106 to online accounts 504 and/or introduction devices 104, 204 and/or receiving devices 110 that are associated with the Device ID.

In addition, a code 106 could also contain and/or be accompanied by information that designates a specific online service and/or other destination to which an online account 504 and/or receiving device 110 would need to send the code 106 to access the related set of information in a memory system 101. In addition, if a code 106 relates to a set of information that the recipient could edit, the set of information could be saved in the recipient user's online account's 504 memory system 101, and could be assigned a new code 106 that contains and/or is accompanied by information that designates that user's online account 504 memory system 101 service as the destination to which an online account 504 and/or receiving device 110 would need to send the code 106 to access the related set of information. On the other hand, if the set of information related to the code 106 was not a set of information that the recipient of the code 106 could edit and/or copy, such set of information and/or code 106 could remain in the original user's online account 504 memory system 101 and the code 106 recipient's online account could just access the set of information related to the code 106 each time the user accesses their online account 504 and/or such set of information and/or code 106, and as a result the code 106 in this example would stay the same as it originally was when sent by the original user.

In another example, codes 106 and/or Device ID's and/or online account 504 services have letters, numbers and/or symbols, like “T01” which are a specific online account 504 service prefix (or include any other identifier, mark, or other data that is part of or sent with the Device ID and/or code 106) that assists in routing the codes 106 to the proper online accounts 504 and/or memory systems 101.

In another example, there could be a company that issues all codes 106 and that maintains lists of Device ID's and/or online accounts 504 and/or other memory system 101 internet destinations, so that all receiving devices 10 would upload codes 106 to this company, which would then reroute such codes 106 to appropriate online accounts 504 and/or memory systems 101.

In another example, information access system devices have software that manages the sending of codes 106 to the desired destinations (including online accounts 504 and/or other memory system 101 destinations) based on information in such software and/or contained in and/or accompanying codes 106.

In another example, a receiving device 110 could be set up to only accept and/or store codes 106 that are accompanied by a password and/or certain other information. In addition, an introduction device 104, 204 could be set up to only transmit a code 106 to receiving devices that are transmitting a password and/or certain other information.

In another example, an introduction device 104, 204 could require a password and/or other information in order to access and/or transmit certain codes 106, such as codes 106 relating to financial information.

In another example, an introduction device 104, 204 and/or receiving device 110 could have no power source of its own (or an inadequate power source to transmit codes 106 as required), but could instead draw any power necessary to transmit a code 106 through the device sending or receiving such code 106.

Note that the embodiments of FIGS. 1-14 can be altered where appropriate so that some information access system devices could be set up so that a code 106 is transmitted as a frequency that a receiving device 110 and/or online account 504 converts into another from of data, such as an alpha/numeric sequence, based upon such frequency. In addition, the code 106 could just be sent as data through a frequency or signal. In addition, a receiving device 110 could be set to only accept codes 106, and/or an introduction device 104, 204 could be set up to only send codes 106, that are sent as data transmitted through one or more frequencies.

Other examples of additional data that could be transmitted to receiving devices 110 with or without a code 106, include advertisements and/or any other information. The information could be designed to simply pass from device to device, for example as a means to pass advertisements or other data, and/or could be used to access the network of information access system devices. For example, if there was a communications failure (for example internet and all phone lines were inoperable), emergency data could be transmitted from device to device.

Another example of a feature that an online account 504 could have includes the ability to pull from emails (sent to such online account 504 and/or the related internet service and in some way designated to the specific online account 504) sets of information and/or codes 106 and/or any additional information transmitted to receiving devices 110. Such sets of information and/or codes 106 and/or any such additional information could then be sent to and added to the applicable online account 504 as appropriate. For example, a user with a receiving device 110 that has only email capabilities, or limited internet capabilities, could find emailing sets of information and/or codes 106 and/or any such additional information received on the receiving device 110 as the preferred method of uploading codes 106 and such other information to their online account 504. A receiving device 10 could also be programmed to automatically send codes 106 and any such additional information in an email form without a user preparing an email themselves. In addition, a user could transmit a code 106 to a recipient's receiving device 110 by emailing such code from such introduction device 104, 204 to such receiving device 110.

In addition, in order to allow a user to have control over when codes 106 are uploaded, some devices could require that a user push a button or otherwise select in some manner when to upload codes 106, and/or some devices could be set up to only upload codes 106 when connected to a base station or certain computers and/or devices and/or categories of computers (for example, the device could permit uploading at any ATM as well as when connected to the user's home computer).

In addition, a user could create a set of information and assign it to a code 106 through an online service in a manner that is not tied to a user's online account 504, such that the identity of the person that created the set of information related to a code 106 could be anonymous.

In addition, an online account 504 could allow a user to organize data, sets of information, codes 106, and any other information, in many different ways (there could also be default settings). For example, a thumbnail, picture, video, audio, and/or any other text or content appear by specified codes 106 and/or sets of information, which could, among other things, be based upon the identity of the person or company that created the set of information, and/or any other factors and/or characteristics, or as selected by the user.

In addition, sets of information related to codes 106 could be stored in any manner, including but not limited to, once a code 106 is sent to an online account 504 and the user selects to access the related set of information, such set of information (data) (a) could then be stored on (i) such user's computer or other device or property (disk, external drive, etc.) or (ii) in such user's online account 504, (b) could continue to be stored in the memory system 101 of the original user that assigned the code 106, or (c) could be stored in memory of an online service and not tied to any specific user, or (d) any combination of the preceding.

In addition, a user could designate a set of information to a code 106 by clicking on an image, video, filename and/or other item. For example, a user right clicks on a mouse when the cursor is on an image, and a menu is brought up that includes an option for assigning a code 106 to such image (and/or adding to a set of information for a code 106 already designated to the set of information). The user could be given the option of using a pre-existing filename as the description to accompany and identify the code 106, or the user could create a new description of their choosing.

Another example of an advantage of the use of the code 106 and information access system devices is that through the transmission of a code 106 in an email, a recipient can successfully gain access to a set of information in situations where the set of information would be too great of a size for a company's and/or individual's filter to allow a recipient to receive.

Additional examples of the content of sets of information related to codes 106 include, but are not limited to, textual information, audio information, video information, music, an image, a computer program, a document, a real time text, audio and/or video communication, or a combination of one or more of the preceding.

Note that the embodiments of FIGS. 1-14 can be altered where appropriate so that a receiver 116 receives additional information from a location external to such receiving device 110 in addition to such code 106, wherein the additional information comprises instructions regarding the destination the code 106 and/or related set of information is to be transmitted and/or manner of such transmission. In addition, in one embodiment, the receiving device 110 also includes a transmitter that sends the code 106 and such additional information to a location external of the receiving device 110, wherein the code 106 contains information allowing a second entity that received such code 106 to access, upon transmission of the code 106 to a memory system 101 in which the set of information is present, the set of information present in the external memory system 101. Among other uses, the preceding will allow certain receiving devices 110 to act as conduits for other receiving devices 110 and aid the related user in transmitting codes 106 and/or related sets of information as desired.

Note that the embodiments of FIGS. 1-14 can be altered where appropriate so that some information access system devices could be set up so that a single transmitter 114, 206, 808 can perform the functions that FIGS. 1-14 indicate that more than one transmitter 114, 206, 808 would be utilized to transmit. In addition, note that the embodiments of FIGS. 1-14 can be altered where appropriate so that some information access system devices could be set up so that multiple transmitters 114, 206, 808 (for example, separate transmitters for separate types of signals, such as a radio transmitter to connect to memory system 101 and a BlueTooth™ transmitter 114, 206, 808 for sending codes 106 to other information access system devices) can perform the functions that FIGS. 1-14 indicate that a single transmitter 114, 206, 808 would be utilized to transmit.

Note that the embodiments of FIGS. 1-14 can be altered where appropriate so that some information access system devices could be set up so that a single receiver 116, 166, 162, 304, 506, 505, 804, 825 can perform the functions for which FIGS. 1-14 indicate more than one receiver 116, 166, 162, 304, 506, 505, 804, 825 would be utilized. In addition, note that the embodiments of FIGS. 1-14 can be altered where appropriate so that some information access system devices could be set up so that multiple receivers 116, 166, 162, 304, 506, 505, 804, 825 can perform the functions for which FIGS. 1-14 indicate a single receiver 116, 166, 162, 304, 506, 505, 804, 825 would be utilized.

Note that the embodiments of FIGS. 1-14 can be altered where appropriate so that some information access system devices could be set up so that a single memory 102, 108, 110, 118, 310, 508, 512, 806 can perform the functions for which FIGS. 1-14 indicate more than one memory 102, 108, 110, 118, 310, 508, 512, 806 would be utilized. In addition, note that the embodiments of FIGS. 1-14 can be altered where appropriate so that some information access system devices could be set up so that multiple memories 102, 108, 110, 118, 310, 508, 512, 806 can perform the functions for which FIGS. 1-14 indicate a single memory 102, 108, 110, 118, 310, 508, 512, 806 would be utilized.

Note that the embodiments of FIGS. 1-14 can be altered where appropriate so that some information access system devices could be set up so that a single reading device 156, 311 can perform the functions for which FIGS. 1-14 indicate more than one reading device 156, 311 would be utilized. In addition, note that the embodiments of FIGS. 1-14 can be altered where appropriate so that some information access system devices could be set up so that multiple reading devices 156, 311 can perform the functions for which FIGS. 1-14 indicate a single reading device 156, 311 would be utilized.

The embodiments of FIGS. 1-14 include in the preferred embodiments a code 106 that is a universal code 106 that can be sent to a plurality of entities besides party A and party B without needing to know any information regarding said plurality of entities, and can be further sent by any such entities to other entities. For example, this allows a user to receive and then resend a code 106 from their introduction and receiving device 802 with just the push of a button (for example) with no need to address and/or format the code 106 as a precondition to successfully transmitting it to other desired recipients. In addition, in the preferred embodiments, such code 106 is also readable regardless of the identity of a user that receives it, and the user is not required to know any specific information identifying a receiving device 110, any other information access system device and/or the entity that is the intended recipient, in order to successfully transmit a code 106 to such entity. As mentioned previously, these attributes provide a person with significantly greater convenience, can increase productivity and provide business opportunities, and can also increase their ability to communicate and transfer information without disclosing personal contact information, as well as provide many other advantages as discussed above.

The invention may be embodied in other forms than those specifically disclosed herein without departing from its spirit or essential characteristics. The described embodiments are to be considered in all respects only as illustrative and not restrictive, and the scope of the invention is commensurate with the appended claims rather than the foregoing description.

I claim:

1. A system for transferring information between a first entity and a second entity, the system comprising:
a set of information to which said first entity has access and said set of information is present in a memory that is at a location that does not coincide with a location of said first entity; and
an introduction device that comprises a code, wherein said introduction device comprises a transmitter that sends said code to a receiver of said second entity, wherein said code contains information that allows access, upon transmission of said code to said memory, to said set of information present in said memory.

2. The system of claim 1, further comprising a display system that receives at least a part of said set of information from said memory and displays at least a part of said set of information upon said code allowing access to said set of information present in said memory.

3. The system of claim 1, wherein said receiver receives at least a part of said set of information from said memory upon said code allowing access to said set of information present in said memory.

4. The system of claim 1, further comprising a second receiver, said second receiver receives at least a part of said set of information from said memory upon said code allowing access to said set of information present in said memory.

5. The system of claim 1, wherein said introduction device does not require any specific information identifying said receiver or said second entity in order to successfully transmit said code to said receiver.

6. The system of claim 1, further comprising an external server that comprises an online account of said second entity that receives said code and transmits said code to said memory so as to access said set of information.

7. The system of claim 6, wherein said online account, upon accessing said set of information, transmits at least a part of said set of information to a predetermined device of said second entity as indicated in account preferences located in said online account.

8. The system of claim 1, wherein said second entity transmits said code to said memory, and wherein at least a part of said set of information is transmitted to a device of said second entity as indicated in a transmission to said memory by said second entity.

9. The system of claim 8, wherein said device of said second entity is an external server that comprises an online account of said second entity.

10. The system of claim 1, wherein said code comprises information and/or is accompanied by information that serves to identify said code and/or said set of information to said first entity and/or said second entity.

11. The system of claim 1, wherein said introduction device comprises a display that displays said code and/or information related to said code.

12. The system of claim 11, wherein said introduction device stores a second code and/or information related to said second code that is displayed on said display and said introduction device comprises a selection device that allows said first user to select either said code and/or said information related to said code or said second code and/or said information related to said second code displayed on said display of said device so as to be sent by said transmitter to said receiver of said second entity.

13. The system of claim 1, wherein said code is readable regardless of the identity of a user that receives it.

14. The system of claim 1, wherein said code is a universal code that can be sent to a plurality of entities besides said first entity and said second entity without needing to know any information regarding said plurality of entities, and can be further sent by any such entities to other entities.

15. The system of claim 1, wherein a receiving device containing said receiver sends, besides said code, additional information to said memory, wherein said additional information comprises instructions regarding where said code and/or at least a part of said set of information is to be transmitted.

16. The system of claim 1, wherein a receiving device containing said receiver sends, besides said code, additional information to a second receiver of an uploading device, wherein said additional information comprises instructions regarding where said code and/or at least a part of said set of information is to be transmitted.

17. The system of claim 16, wherein said second receiver receives, besides said code, additional information from a location external to said uploading device, wherein said additional information comprises instructions regarding where said code and/or set of information is to be transmitted.

18. The system of claim 17, wherein said second receiver is in communication with a second memory for storing said additional information, which is in communication with a reading device that reads said additional information, which is in communication with a second transmitter for sending said code and/or said set of information in accordance with said additional information.

19. The system of claim 1, wherein said introduction device transmits said code wirelessly to said receiver and wherein said introduction device and/or said receiving device containing said receiver is portable.

20. The system of claim 1, wherein said set of information comprises information selected from the group consisting of: textual information, audio information, video information, music, an image, a computer program, a document, a real time text, audio and video communication.

21. The system of claim 10, wherein said first entity selects content of said information that serves to identify said code and/or said set of information to said first entity and/or said second entity.

22. The system of claim 1, wherein said introduction device comprises a second receiver for receiving said code from said memory in which said set of information is present.

23. A method for transferring information between a first entity and a second entity, the method comprising:
presenting a set of information to which said first entity has access in a memory that is at a location that does not coincide with a location of said first entity; and
sending a code to said second entity, wherein said code contains information that allows access, upon transmission of said code to said memory, to said set of information present in said memory.

24. The method of claim 23, further comprising displaying at least a part of said set of information upon said code allowing access to said set of information present in said memory.

25. The method of claim 23, further comprising transmitting at least a part of said set of information from said memory to a receiver, said receiver receives at least a part of said set of information from said memory upon said code allowing access to said set of information present in said memory.

26. The method of claim 23, further comprising transmitting said code from said second entity to an online account of said second entity that receives said code and transmits said code to said memory so as to access said set of information.

27. The method of claim 26, further comprising transmitting at least a part of said set of information from said online account, upon accessing said set of information, to a predetermined device of said second entity as indicated in account preferences located in said online account.

28. The method of claim 23, further comprising transmitting said code from said second entity to said memory, and wherein at least a part of said set of information is transmitted to a device of said second entity as indicated in a transmission to said memory by said second entity.

29. The method of claim 28, wherein said device of said second entity is an external server that comprises an online account of said second entity.

30. The method of claim 23, wherein said code comprises information and/or is accompanied by information that serves to identify said code and/or said set of information to said first entity and/or said second entity.

31. The method of claim 23, wherein said first entity has a device that stores said code and a second code, said method further comprising selecting either said code or said second code so as to be sent to said second entity.

32. The method of claim 23, wherein said code is readable regardless of the identity of a user that receives it.

33. The system of claim 23, wherein said code is a universal code that can be sent to a plurality of entities besides said first entity and said second entity without needing to know any information regarding said plurality of entities, and can be further sent by any such entities to other entities.

34. The method of claim 23, wherein said second entity sending, besides said code, additional information to said memory, wherein said additional information comprises instructions regarding where said code and/or at least a part of said set of information is to be transmitted.

35. The method of claim 23, wherein said second entity sending, besides said code, additional information to a receiver of an uploading device, wherein said additional information comprises instructions regarding where said code and/or at least a part of said set of information is to be transmitted.

36. The method of claim 35, wherein said receiver receives additional information from a location external to said uploading device, wherein said additional information comprises instructions regarding where said code and/or at least a part of said set of information is to be transmitted.

37. The method of claim 36, wherein said receiver is in communication with a second memory for storing said additional information, which is in communication with a reading device that reads said additional information, which is in communication with a transmitter for sending said code and/or at least a part of said set of information in accordance with said additional information.

38. The method of claim 23, wherein said first entity does not require any specific information identifying said second entity in order to successfully transmit said code to said second entity.

39. The method of claim 23, wherein said first entity transmits said code wirelessly to said second entity, and wherein said first entity transmits said code from a first portable device and/or second entity receives a transmission of said code on a second portable device.

40. The method of claim 23, wherein said set of information comprises information selected from the group consisting of: textual information, audio information, video information, music, an image, a computer program, a document, a real time text, audio and video communication.

41. The method of claim 30, wherein said first entity selects content of said information that serves to identify said code and/or said set of information to said first entity and/or second entity.

42. The method of claim 23, wherein said first entity receives said code from said memory through a receiver.

43. A system for transferring information between a first entity and a second entity, the system comprising:
means for presenting a set of information to which said first entity has access in a memory that is at a location that does not coincide with a location of said first entity; and
means for sending a code to said second entity, wherein said code contains information that allows access, upon transmission of said code to said memory, to said set of information present in said memory.

44. The system of claim 43, further comprising a display system that receives at least a part of said set of information from said memory and displays at least a part of said set of information upon said code allowing access to said set of information present in said memory.

45. The system of claim 43, further comprising a receiver, said receiver receives at least a part of said set of information from said memory upon said code allowing access to said set of information present in said memory.

46. The system of claim 43, further comprising an external server that comprises an online account of said second entity that receives said code and transmits said code to said memory so as to access said set of information.

47. The system of claim 46, wherein said online account, upon accessing said set of information, transmits at least a part of said set of information to a predetermined device of said second entity as indicated in account preferences located in said online account.

48. The system of claim 43, wherein said second entity transmits said code to said memory, and wherein at least a part of said set of information is transmitted to a device of said second entity as indicated in a transmission to said memory by said second entity.

49. The system of claim 48, wherein said device of said second entity is an external server that comprises an online account of said second entity.

50. The system of claim 43, wherein said code comprises information and/or is accompanied by information that serves to identify said code and/or said set of information to said first entity and/or said second entity.

51. The system of claim 43, wherein said first entity has a device that stores said code and a second code and said system further comprising a selection device that allows said first user to select either said code and/or said second code so as to be sent to said second entity.

52. The system of claim 43, wherein said code is readable regardless of the identity of a user that receives it.

53. The system of claim 43, wherein said code is a universal code that can be sent to a plurality of entities besides said first entity and said second entity without needing to know any information regarding said plurality of entities, and can be further sent by any such entities to other entities.

54. The system of claim 43, further comprising means for said second entity to send, besides said code, additional information to said memory, wherein said additional information comprises instructions regarding where said code and/or at least a part of said set of information is to be transmitted.

55. The system of claim 43, further comprising means for said second entity to send, besides said code, additional information to a second means for receiving of an uploading device, wherein said additional information comprises instructions regarding where said code and/or at least a part of said set of information is to be transmitted.

56. The system of claim 55, wherein said second means for receiving receiving additional information in addition to said code from a location external to said uploading device, wherein said additional information comprises instructions regarding where said code and/or at least a part of said set of information is to be transmitted.

57. The system of claim 56, further comprising: a means for storing said additional information, means for reading said additional information, and a means for sending said code and/or at least a part of said set of information in accordance with said additional information.

58. The system of claim 43, wherein said first entity does not require any specific information identifying said second entity in order to successfully transmit said code to said second entity.

59. The system of claim 43, wherein said first entity transmits said code wirelessly to said second entity, and wherein said first entity transmits said code from a first portable device and/or said second entity receives a transmission of said code on a second portable device.

60. The system of claim 43, wherein said set of information comprises information selected from the group consisting of: textual information, audio information, video information, music, an image, a computer program, a document, a real time text, audio and video communication.

61. The system of claim 50, wherein said first entity selects content of said information that serves to identify said code and/or said set of information to said first entity and/or said second entity.

62. The system of claim 43, wherein said first entity receives said code from said memory through a receiver.

63. A memory system for enabling the transfer of information between a first entity and a second entity and enabling said first entity to manage information, the memory system comprising:
a memory in which is present a set of information to which said first entity has access;
a system that assigns a code to said set of information, wherein said code contains information allowing said second entity that receives said code access to said set of information present in said memory;
an output for providing said code;
an input for receiving a transmission comprising said code from a location external to said memory system;
a reading device that is in communication with said input and reads said code; and
said memory is in communication with said reading device, wherein upon reading said code said reading device allows access to said set of information to an entity that is located external to said memory system.

64. The memory system of claim 63, further comprising a display system that receives at least a part of said set of information from said memory and displays at least a part of said set of information upon said code allowing access to said set of information present in said memory.

65. The memory system of claim 63, further comprising a receiver, said receiver receives at least a part of said set of information from said memory upon said code allowing access to said set of information present in said memory.

66. The memory system of claim 63, further comprising an external server that comprises an online account of said second entity that receives said code and transmits said code to said memory so as to access said set of information.

67. The memory system of claim 66, wherein said online account, upon accessing said set of information, transmits at least a part of said set of information to a predetermined device of said second entity as indicated in account preferences located in said online account.

68. The memory system of claim 63, wherein said second entity transmits said code to said memory, and wherein at least a part of said set of information is transmitted to a device of said second entity as indicated in a transmission to said memory by said second entity.

69. The memory system of claim 68, wherein said device of said second entity is an external server that comprises an online account of said second entity.

70. The memory system of claim 63, wherein said code comprises information and/or is accompanied by information that serves to identify said code and/or said set of information to said first entity and/or said second entity.

71. The memory system of claim 63, further comprising a first entity device that comprises a display that displays said code and/or information related to said code.

72. The memory system of claim 71, wherein a second code and/or information related to said second code is displayed on said display, said first entity device further comprising a selection device that allows said first user to select either said code and/or said information related to said code or said second code and/or said information related to said second code displayed on said display of said device so as to be sent to said second entity.

73. The memory system of claim 63, wherein said input receives a transmission comprising additional information from a location external to said memory system, said reading device reads said additional information and, wherein upon reading said additional information at least a part of said set of information and/or said code is sent to a location per instructions contained in said additional information.

74. The memory system of claim 63, wherein said code is readable regardless of the identity of a user that receives it.

75. The system of claim 63, wherein said code is a universal code that can be sent to a plurality of entities besides said first entity and said second entity without needing to know any information regarding said plurality of entities, and can be further sent by any such entities to other entities.

76. The memory system of claim 63, wherein said first entity transmits said code wirelessly to said second entity, and wherein said first entity transmits said code from a first portable device and/or said second entity receives a transmission of said code on a second portable device.

77. The memory system of claim 63, wherein said set of information comprises information selected from the group consisting of: textual information, audio information, video information, music, an image, a computer program, a document, a real time text, audio and video communication.

78. The memory system of claim 70, wherein said first entity selects content of the information that is used to identify said code and/or said set of information to said first entity and/or said second entity.

79. The memory system of claim 63, wherein said first entity does not require any specific information identifying said second entity in order to successfully transmit said code to said second entity.

80. The memory system of claim 63, wherein first entity receives said code from said memory through a receiver.

81. An introduction device for enabling the transfer of information between a first entity and a second entity, the introduction device comprising:
a memory that includes a code associated with a set of information to which said first entity has access, wherein said set of information is present in a memory system;
a transmitter in communication with said memory, said transmitter sends said code externally of said introduction device, wherein said code contains information allowing said second entity that received said code access, upon transmission of said code to said memory system, to said set of information present in said memory system.

82. The introduction device of claim 81, wherein said introduction device does not require any specific information identifying said second entity in order to successfully transmit said code to said second entity.

83. The introduction device of claim 81, wherein said code comprises information and/or is accompanied by information that serves to identify said code and/or said set of information to said first entity and/or said second entity.

84. The introduction device of claim 81, wherein said introduction device comprises a display that displays said code and/or information related to said code that is stored on said introduction device.

85. The introduction device of claim 84, wherein said introduction device stores a second code and/or information related to said second code that is displayed on said display and said introduction device comprises a selection device that allows said first user to select either said code and/or said information related to said code or said second code and/or said information related to said second code displayed on said display of said introduction device so as to be sent by said transmitter to said second entity.

86. The introduction device of claim 81, further comprising a display system that receives at least a part of said set of information from said memory and displays at least a part of said set of information upon said code allowing access to said set of information present in said memory.

87. The introduction device of claim 81, wherein there is a receiver, and said receiver receives at least a part of said set of information from said memory upon said code allowing access to said set of information present in said memory.

88. The introduction device of claim 81, wherein said code is readable regardless of the identity of a user that receives it.

89. The system of claim 81, wherein said code is a universal code that can be sent to a plurality of entities besides said first entity and said second entity without needing to know any information regarding said plurality of entities, and can be further sent by any such entities to other entities.

90. The introduction device of claim 81, wherein said introduction device transmits said code wirelessly to said second entity, and wherein said introduction device is a first portable device and/or second entity receives a transmission of said code on a second portable device.

91. The introduction device of claim 81, wherein said set of information comprises information selected from the group consisting of: textual information, audio information, video information, music, an image, a computer program, a document, a real time text, audio and video communication.

92. The introduction device of claim 83, wherein said first entity selects content of the information that is used to identify said code and/or said set of information to said first entity and/or said second entity.

93. The introduction device of claim 81, wherein said introduction device receives said code from said memory through a receiver.

94. A receiving device for enabling the transfer of information between a first entity and a second entity, the receiving device comprising:
a receiver for receiving from a location external to said receiving device a code associated with a set of information to which said first entity has access, wherein said set of information is present in an external memory system;
a memory that is in communication with said receiver and stores said code;
a transmitter in communication with said memory, where said transmitter sends said code to said external memory system, and where said code contains information allowing said second entity that received said code access to said set of information present in said external memory system.

95. The receiving device of claim 94, wherein said receiver receives at least a part of said set of information from said external memory system upon said code allowing access to said set of information present in said external memory system.

96. The receiving device of claim 94, further comprising a second receiver, said second receiver receives at least a part of said set of information from said external memory system upon said code allowing access to said set of information present in said external memory system.

97. The receiving device of claim 94, further comprising an external server that comprises an online account of said second entity that receives said code and transmits said code to said external memory system so as to access said set of information.

98. The receiving device of claim 97, wherein said online account, upon accessing said set of information, transmits at least a part of said set of information to a predetermined device of said second entity as indicated in account preferences located in said online account.

99. The receiving device of claim 94, wherein said second entity transmits said code to said external memory system, and wherein at least a part of said set of information is transmitted to a device of said second entity as indicated in a transmission to said external memory system by said second entity.

100. The receiving device of claim 99, wherein said device of said second entity is an external server that comprises an online account of said second entity.

101. The receiving device of claim 94, wherein said code comprises information and/or is accompanied by information that serves to identify said code and/or said set of information to said first entity and/or said second entity.

102. The receiving device of claim 94, wherein said code is readable regardless of the identity of a user that receives it.

103. The system of claim 94, wherein said code is a universal code that can be sent to a plurality of entities besides said first entity and said second entity without needing to know any information regarding said plurality of entities, and can be further sent by any such entities to other entities.

104. The receiving device of claim 94, wherein said receiving device sends, besides said code, additional information to said external memory system, wherein said additional information comprises instructions regarding where said code and/or at least a part of said set of information is to be transmitted.

105. The receiving device of claim 94, wherein said receiving device sends, besides said code, additional information to a second receiver of an uploading device, wherein said additional information comprises instructions regarding where said code and/or at least a part of said set of information is to be transmitted.

106. The receiving device of claim 105, wherein said second receiver receives, besides said code, additional information from a location external to said uploading device, wherein said additional information comprises instructions regarding where said code and/or at least a part of said set of information is to be transmitted.

107. The receiving device of claim 106, wherein said second receiver is in communication with a second memory for storing said additional information, which is in communication with a reading device that reads said additional information, which is in communication with a second transmitter for sending said code and/or at least a part of said set of information in accordance with said additional information.

108. The receiving device of claim 95, further comprising a display system that receives at least a part of said set of information from said external memory system and displays at least a part of said set of information upon said code allowing access to said set of information present in said external memory system.

109. The receiving device of claim 95, wherein said first entity does not require any specific information identifying said receiving device or said second entity in order to successfully transmit said code to said receiving device.

110. The receiving device of claim 95, wherein said receiving device stores a second code and/or information related to said second code that is displayed on a display and said receiving device comprises a selection device that allows said second user to select either said code and/or information related to said code or said second code and/or said information related to said second code displayed on said display of said receiving device to further transmit.

111. The receiving device of claim 95, wherein said first entity transmits said code wirelessly to said receiver, and wherein said first entity transmits said code from a first portable device and/or said receiving device is a second portable device.

112. The receiving device of claim 95, wherein said set of information comprises information selected from the group consisting of: textual information, audio information, video information, music, an image, a computer program, a document, a real time text, audio and video communication.

113. A receiving device for enabling the transfer of information between a first entity and a second entity, the receiving device comprising:
a receiver for receiving from a location external to said receiving device a code associated with a set of information to which said first entity has access, wherein said set of information is present in an external memory system;
a memory that is in communication with said receiver and stores said code;
an interface with an external transmitter in communication with said memory, where said transmitter sends said code to a location external to said receiving device, and wherein said code contains information allowing said second entity that received said code access, upon transmission of said code to said external memory system, to said set of information present in said external memory system.

114. The receiving device of claim 113, wherein said receiver receives at least a part of said set of information from said external memory system upon said code allowing access to said set of information present in said external memory system.

115. The receiving device of claim 113, further comprising a second receiver, said second receiver receives at least a part of said set of information from said external memory system upon said code allowing access to said set of information present in said external memory system.

116. The receiving device of claim 113, further comprising an external server that comprises an online account of said second entity that receives said code and transmits said code to said external memory system so as to access said set of information.

117. The receiving device of claim 116, wherein said online account, upon accessing said set of information, transmits at least apart of said set of information to a predetermined device of said second entity as indicated in account preferences located in said online account.

118. The receiving device of claim 113, wherein said second entity transmits said code to said external memory system, and wherein at least a part of said set of information is transmitted to a device of said second entity as indicated in a transmission to said external memory system by said second entity.

119. The receiving device of claim 118, wherein said device of said second entity is an external server that comprises an online account of said second entity.

120. The receiving device of claim 113, wherein said code comprises information and/or is accompanied by information that serves to identify said code and/or said set of information to said first entity and/or said second entity.

121. The receiving device of claim 113, wherein said code is readable regardless of the identity of a user that receives it.

122. The system of claim 113, wherein said code is a universal code that can be sent to a plurality of entities besides said first entity and said second entity without needing to know any information regarding said plurality of entities, and can be further sent by any such entities to other entities.

123. The receiving device of claim 113, wherein said receiving device sends, besides said code, additional information to said external memory system, wherein said additional information comprises instructions regarding where said code and/or at least a part of said set of information is to be transmitted.

124. The receiving device of claim 113, wherein said receiving device sends, besides said code, additional information to a second receiver of an uploading device, wherein said additional information comprises instructions regarding where said code and/or at least a part of said set of information is to be transmitted.

125. The receiving device of claim 124, wherein said second receiver receives besides said code additional information from a location external to said uploading device, wherein said additional information comprises instructions regarding where said code and/or at least a part of said set of information is to be transmitted.

126. The receiving device of claim 125, wherein said second receiver is in communication with a second memory for storing said additional information, which is in communication with a reading device that reads said additional information, which is in communication with a second transmitter for sending said code and/or at least a part of said set of information in accordance with said additional information.

127. The receiving device of claim 113, further comprising a display system that receives at least a part of said set of information from said external memory system and displays at least a part of said set of information upon said code allowing access to said set of information present in said external memory system.

128. The receiving device of claim 113, wherein said first entity does not require any specific information identifying said receiving device or said second entity in order to successfully transmit said code to said receiver.

129. The receiving device of claim 113, wherein said receiving device stores a second code and/or information related to said second code that is displayed on a display and said receiving device comprises a selection device that allows said second user to select either said code and/or information related to said code or said second code and/or said information related to said second code displayed on said display of said receiving device to further transmit.

130. The receiving device of claim 113, wherein said first entity transmits said code wirelessly to said receiver, and wherein said first entity transmits said code from a first portable device and/or said receiving device is a second portable device.

131. The receiving device of claim 113, wherein said set of information comprises information selected from the group consisting of: textual information, audio information, video information, music, an image, a computer program, a document, a real time text, audio and video communication.

132. A receiving device for enabling the transfer of information between a first entity and a second entity, the receiving device comprising:
a receiver for receiving from a location external to said receiving device a code associated with a set of information to which said first entity has access, wherein said set of information is present in an external memory system;
a memory that is in communication with said receiver and stores said code;
a transmitter in communication with said memory, said transmitter sends said code to a location external to said receiving device, wherein said code contains information allowing said second entity that received said code access, upon transmission of said code to said external memory system, to said set of information present in said external memory system.

133. The receiving device of claim 132, wherein said receiver receives at least a part of said set of information from said external memory system upon said code allowing access to said set of information present in said external memory system.

134. The receiving device of claim 132, further comprising a second receiver, said second receiver receives at least a part of said set of information from said external memory system upon said code allowing access to said set of information present in said external memory system.

135. The receiving device of claim 132, further comprising an external server that comprises an online account of said second entity that receives said code and transmits said code to said external memory system so as to access said set of information.

136. The receiving device of claim 135, wherein said online account, upon accessing said set of information, transmits at least a part of said set of information to a predetermined device of said second entity as indicated in account preferences located in said online account.

137. The receiving device of claim 132, wherein said second entity transmits said code to said external memory system, and wherein at least a part of said set of information is transmitted to a device of said second entity as indicated in a transmission to said external memory system by said second entity.

138. The receiving device of claim 137, wherein said device of said second entity is an external server that comprises an online account of said second entity.

139. The receiving device of claim 132, wherein said code comprises information and/or is accompanied by information that serves to identify said code and/or said set of information to said first entity and/or said second entity.

140. The receiving device of claim 132, wherein said code is readable regardless of the identity of a user that receives it.

141. The system of claim 132, wherein said code is a universal code that can be sent to a plurality of entities besides said first entity and said second entity without needing to know any information regarding said plurality of entities, and can be further sent by any such entities to other entities.

142. The receiving device of claim 132, wherein said receiving device sends, besides said code, additional information to said external memory system, wherein said additional information comprises instructions regarding where said code and/or at least a part of said set of information is to be transmitted.

143. The receiving device of claim 132, wherein said receiving device sends, besides said code, additional information to a second receiver of an uploading device, wherein said additional information comprises instructions regarding where said code and/or at least a part of said set of information is to be transmitted.

144. The receiving device of claim 143, wherein said second receiver receives, besides said code, additional information from a location external to said uploading device, wherein said additional information comprises instructions regarding where said code and/or at least a part of said set of information is to be transmitted.

145. The receiving device of claim 144, wherein said second receiver is in communication with a second memory for storing said additional information, which is in communication with a reading device that reads said additional information, which is in communication with a second transmitter for sending said code and/or at least a part of said set of information in accordance with said additional information.

146. The receiving device of claim 132, further comprising a display system that receives at least a part of said set of information from said external memory system and displays at least a part of said set of information upon said code allowing access to said set of information present in said external memory system.

147. The receiving device of claim 132, wherein said first entity does not require any specific information identifying said receiving device or said second entity in order to successfully transmit said code to said receiver.

148. The receiving device of claim 132, wherein said receiving device stores a second code and/or information related to said second code that is displayed on a display and said receiving device comprises a selection device that allows said second user to select either said code and/or information related to said code and/or said second code and/or said information related to said second code displayed on said display of said receiving device to further transmit.

149. The receiving device of claim 132, wherein said first entity transmits said code wirelessly to said receiver, and wherein said first entity transmits said code from a first portable device and/or said receiving device is a second portable device.

150. The receiving device of claim 132, wherein said set of information comprises information selected from the group consisting of: textual information, audio information, video information, music, an image, a computer program, a document, a real time text, audio and video communication.

151. A method of transferring information between a first entity and a second entity, the method comprising:
said second entity receiving from an external location a code associated with a set of information to which said first entity has access, wherein said set of information is present in an external memory system;
storing said code; and
transmitting said code to said external memory system, wherein said code contains information allowing said second entity that received said code access to said set of information present in said external memory system.

152. The method of claim 151, further comprising displaying at least a part of said set of information upon said code allowing access to said set of information present in said external memory system.

153. The method of claim 151, further comprising transmitting at least a part of said set of information from said external memory system to a receiver, said receiver receives at least a part of said set of information from said external memory system upon said code allowing access to said set of information present in said external memory system.

154. The method of claim 151, further comprising transmitting said code from said second entity to an online account of said second entity that receives said code and transmits said code to said external memory system so as to access said set of information.

155. The method of claim 154, further comprising transmitting at least a part of said set of information from said online account, upon accessing said set of information, to a predetermined device of said second entity as indicated in account preferences located in said online account.

156. The method of claim 151, further comprising transmitting said code from said second entity to said external memory system, and wherein at least a part of said set of information is transmitted to a device of said second entity as indicated in a transmission to said external memory system by said second entity.

157. The method of claim 156, wherein said device of said second entity is an external server that comprises an online account of said second entity.

158. The method of claim 151, wherein said code comprises information and/or is accompanied by information that serves to identify said code and/or said set of information to said first entity and/or said second entity.

159. The method of claim 151, wherein said code is readable regardless of the identity of a user that receives it.

160. The system of claim 151, wherein said code is a universal code that can be sent to a plurality of entities besides said first entity and said second entity without needing to know any information regarding said plurality of entities, and can be further sent by any such entities to other entities.

161. The method of claim 151, further comprising sending, besides said code, additional information to said external memory system, wherein said additional information comprises instructions regarding where said code and/or at least a part of said set of information is to be transmitted.

162. The method of claim 151, further comprising sending, besides said code, additional information to a receiver of an uploading device, wherein said additional information comprises instructions regarding where said code and/or at least a part of said set of information is to be transmitted.

163. The method of claim 162, further comprising receiving on said receiver besides said code additional information, wherein said additional information comprises instructions regarding where said code and/or at least a part of said set of information is to be transmitted.

164. The method of claim 163, further comprising storing said additional information, reading said additional information, and sending said code and/or at least a part of said set of information in accordance with said additional information.

165. The method of claim 151, wherein said first entity does not require any specific information identifying said second entity in order to successfully transmit said code to said second entity.

166. The method of claim 151, wherein said first entity transmits said code wirelessly, and wherein said first entity transmits said code from a first portable device and/or said second entity receives said code on a second portable device.

167. The method of claim 151, wherein said set of information comprises information selected from the group consisting of: textual information, audio information, video information, music, an image, a computer program, a document, a real time text, audio and video communication.

168. A method of transferring information between a first entity and a second entity, the method comprising:
receiving from an external location a code associated with a set of information to which said first entity has access, wherein said set of information is present in an external memory system;
storing said code; and
interfacing with an external transmitter, where said external transmitter sends said code to a location external to said receiving device, and wherein said code contains information allowing said second entity that received said code access, upon transmission of said code to said external memory system, to said set of information present in said external memory system.

169. The method of claim 168, further comprising displaying at least a part of said set of information upon said code allowing access to said set of information present in said external memory system.

170. The method of claim 168, further comprising transmitting at least a part of said set of information from said external memory system to a receiver, said receiver receives at least a part of said set of information from said external memory system upon said code allowing access to said set of information present in said external memory system.

171. The method of claim 168, further comprising transmitting said code from said second entity to an online account of said second entity that receives said code and transmits said code to said external memory system so as to access said set of information.

172. The method of claim 171, further comprising transmitting at least a part of said set of information from said online account, upon accessing said set of information, to a predetermined device of said second entity as indicated in account preferences located in said online account.

173. The method of claim 168, further comprising transmitting said code from said second entity to said external memory system, and wherein at least a part of said set of information is transmitted to a device of said second entity as indicated in a transmission to said external memory system by said second entity.

174. The method of claim 173, wherein said device of said second entity is an external server that comprises an online account of said second entity.

175. The method of claim 168, wherein said code comprises information and/or is accompanied by information that serves to identify said code and/or said set of information to said first entity and/or said second entity.

176. The method of claim 168, wherein said code is readable regardless of the identity of a user that receives it.

177. The system of claim 168, wherein said code is a universal code that can be sent to a plurality of entities besides said first entity and said second entity without needing to know any information regarding said plurality of entities, and can be further sent by any such entities to other entities.

178. The method of claim 168, further comprising sending, besides said code, additional information to said external memory system, wherein said additional information comprises instructions regarding where said code and/or at least a part of said set of information is to be transmitted.

179. The method of claim 168, further comprising sending, besides said code, additional information to a receiver of an uploading device, wherein said additional information comprises instructions regarding where said code and/or at least a part of said set of information is to be transmitted.

180. The method of claim 179, further comprising receiving on said receiver, besides said code, additional information, wherein said additional information comprises instructions regarding where said code and/or at least a part of said set of information is to be transmitted.

181. The method of claim 180, further comprising storing said additional information in a memory which is in communication with a reading device that reads said additional information, wherein said memory is in communication with a transmitter for sending said code and/or at least a part of said set of information in accordance with said additional information.

182. The method of claim 168, wherein said first entity does not require any specific information identifying said second entity in order to successfully transmit said code to said second entity.

183. The method of claim 168, wherein said first entity transmits said code wirelessly to said second entity, and wherein said first entity transmits said code from a first portable device and/or said second entity receives said code on a second portable device.

184. The method of claim 168, wherein said set of information comprises information selected from the group consisting of: textual information, audio information, video information, music, an image, a computer program, a document, a real time text, audio and video communication.

185. A method of transferring information between a first entity and a second entity, the method comprising:
receiving at a receiving device, from an external location, a code associated with a set of information to which said first entity has access, wherein said set of information is present in an external memory system; and
storing said code;
transmitting said code to a location external to said receiving device, wherein said code contains information allowing said second entity that received said code access, upon transmission of said code to said external memory system, to said set of information present in said external memory system.

186. The method of claim 185, further comprising displaying at least a part of said set of information upon said code allowing access to said set of information present in said external memory system.

187. The method of claim 185, further comprising transmitting at least a part of said set of information from said external memory system to a receiver, said receiver receives at least a part of said set of information from said external memory system upon said code allowing access to said set of information present in said external memory system.

188. The method of claim 185, further comprising transmitting said code from said second entity to an online account of said second entity that receives said code and transmits said code to said external memory system so as to access said set of information.

189. The method of claim 188, further comprising transmitting at least a part of said set of information from said online account, upon accessing said set of information, to a predetermined device of said second entity as indicated in account preferences located in said online account.

190. The method of claim 185, further comprising transmitting said code from said second entity to said external memory system, and wherein at least a part of said set of information is transmitted to a device of said second entity as indicated in a transmission to said external memory system by said second entity.

191. The method of claim 190, wherein said device of said second entity is an external server that comprises an online account of said second entity.

192. The method of claim 185, wherein said code comprises information and/or is accompanied by information that serves to identify said code and/or the related said set of information to said first entity and/or said second entity.

193. The method of claim 185, further comprising storing a second code, said method further comprising selecting either said code or said second code so as to be sent to an external location.

194. The method of claim 185, wherein said code is readable regardless of the identity of a user that receives it.

195. The system of claim 185 wherein said code is a universal code that can be sent to a plurality of entities besides said first entity and said second entity without needing to know any information regarding said plurality of entities, and can be further sent by any such entities to other entities.

196. The method of claim 185, further comprising sending, besides said code, additional information to said external memory system, wherein said additional information comprises instructions regarding where said code and/or at least a part of said set of information is to be transmitted.

197. The method of claim 185, further comprising sending, besides said code, additional information to a receiver of an uploading device, wherein said additional information comprises instructions regarding where said code and/or at least a part of said set of information is to be transmitted.

198. The method of claim 197, further comprising receiving on said receiver, besides said code, additional information, wherein said additional information comprises instructions regarding where said code and/or at least a part of said set of information is to be transmitted.

199. The method of claim 198, further comprising storing said additional information in a memory, which is in communication with a reading device that reads said additional information, wherein said memory is in communication with a transmitter for sending said code and/or at least a part of said set of information in accordance with said additional information.

200. The method of claim 185, wherein said first entity does not require any specific information identifying said second entity in order to successfully transmit said code to said second entity.

201. The method of claim 185, wherein said first entity transmits said code wirelessly to said second entity, and wherein said first entity transmits said code from a first portable device and/or said second entity receives said code on a second portable device.

202. The method of claim 185, wherein said set of information comprises information selected from the group consisting of: textual information, audio information, video information, music, an image, a computer program, a document, a real time text, audio and video communication.

203. A memory system for enabling the transfer of information between a first entity and a second entity and enabling said first entity to manage information, the memory system comprising:
means for presenting a set of information to which said first entity has access in said memory system;
means for assigning a code to said set of information, wherein said code contains information allowing said second entity that receives said code access to said set of information present in said memory system;
means for providing said code;
means for receiving a transmission comprising said code from a location external to said memory system;
means for reading said code; and
means for allowing access to said set of information external to said memory system based on said code.

204. The memory system of claim 203, further comprising a display system that receives at least a part of said set of information from said memory system and displays at least a part of said set of information upon said code allowing access to said set of information present in said memory system.

205. The memory system of claim 203, further comprising a second means for receiving, said second means for receiving receives at least a part of said set of information from said memory system upon said code allowing access to said set of information present in said memory system.

206. The memory system of claim 203, further comprising an external server that comprises an online account of said second entity that receives said code and transmits said code to said memory system so as to access said set of information.

207. The memory system of claim 206, wherein said online account, upon accessing said set of information, transmits at least a part of said set of information to a predetermined device of said second entity as indicated in account preferences located in said online account.

208. The memory system of claim 203, wherein said second entity transmits said code to said memory system, and wherein at least a part of said set of information is transmitted to a device of said second entity as indicated in a transmission to said memory system by said second entity.

209. The memory system of claim 208, wherein said device of said second entity is an external server that comprises an online account of said second entity.

210. The memory system of claim 203, wherein said code comprises information and/or is accompanied by information that serves to identify said code and/or said set of information to said first entity and/or said second entity.

211. The memory system of claim 203, wherein said means for receiving receives besides said code additional information, wherein said additional information comprises instructions regarding where said code and/or at least a part of said set of information is to be transmitted.

212. The memory system of claim 203, wherein said first entity transmits said code wirelessly to said second entity, and wherein said first entity transmits said code from a first portable device and/or said second entity receives said code on a second portable device.

213. The memory system of claim 203, wherein said set of information comprises information selected from the group consisting of: textual information, audio information, video information, music, an image, a computer program, a document, a real time text, audio and video communication.

214. The memory system of claim 210, wherein said first entity selects content of the information that is used to identify said code and/or said set of information to said first entity and/or said second entity.

215. The memory system of claim 203, wherein said first entity does not require any specific information identifying said second entity in order to successfully transmit said code to said second entity.

216. The memory system of claim 203, further comprising a means for said first entity to receive and/or input said code on a device.

217. A method of transferring information between a first entity and a second entity and enabling said first entity to manage information, the method comprising:
presenting a set of information to which said first entity has access in a memory system;
assigning a code to said set of information, wherein said code contains information allowing said second entity that receives said code access to said set of information present in said memory system;
providing said code to an entity, receiving a transmission comprising said code from a location external to said memory system;
reading said code; and
allowing access to said set of information to an entity that is located external to said memory system.

218. The method of claim 217, further comprising displaying at least a part of said set of information upon said code allowing access to said set of information present in said memory system.

219. The method of claim 217, further comprising transmitting at least a part of said set of information from said memory system to a receiver, said receiver receives at least a part of said set of information from said memory system upon said code allowing access to said set of information present in said memory system.

220. The method of claim 217, further comprising transmitting said code from said second entity to an online account of said second entity that receives said code and transmits said code to said memory system so as to access said set of information.

221. The method of claim 220, further comprising transmitting at least a part of said set of information from said online account, upon accessing said set of information, to a predetermined device of said second entity as indicated in account preferences located in said online account.

222. The method of claim 217, further comprising transmitting said code from said second entity to said memory system, and wherein at least a part of said set of information is transmitted to a device of said second entity as indicated in a transmission to said memory system by said second entity.

223. The method of claim 222, wherein said device of said second entity is an external server that comprises an online account of said second entity.

224. The method of claim 217, wherein said code comprises information and/or is accompanied by information that serves to identify said code and/or said set of information to said first entity and/or said second entity.

225. The method of claim 217, further comprising receiving, besides said code, additional information, wherein said additional information comprises instructions regarding where said code and/or at least a part of said set of information is to be transmitted.

226. The method of claim 217, wherein said first entity transmits said code wirelessly to said second entity, and wherein said first entity transmits said code from a first portable device and/or said second entity receives said code on a second portable device.

227. The method of claim 217, wherein said set of information comprises information selected from the group consisting of: textual information, audio information, video information, music, an image, a computer program, a document, a real time text, audio and video communication.

228. The method of claim 224, wherein said first entity selects the content of said information that serves to identify said code and/or said set of information to said first entity and/or said second entity.

229. The method of claim 217, wherein said first entity does not require any specific information identifying said second entity in order to successfully transmit said code to said second entity.

230. The method of claim 217, further comprising a means for said first entity to receive and/or input said code on a device.

231. An introduction device for enabling the transfer of information between a first entity and a second entity, the introduction device comprising:
means for retaining a code associated with a set of information to which said first entity has access, wherein said set of information is present in a memory system;
means for sending said code externally of said introduction device, wherein said code contains information allowing said second entity that received said code access, upon transmission of said code to said memory system, to said set of information present in said memory system.

232. The introduction device of claim 231, wherein said introduction device does not require any specific information identifying said second entity in order to successfully transmit said code to said second entity.

233. The introduction device of claim 231, wherein said code comprises information and/or is accompanied by information that serves to identify said code and/or said set of information to said first entity and/or said second entity.

234. The introduction device of claim 231, wherein said introduction device comprises a display that displays said code and/or information related to said code that is stored on said introduction device.

235. The introduction device of claim 234, wherein said introduction device stores a second code and/or information related to said second code that is displayed on said display and said introduction device comprises a selection device that allows said first user to select either said code and/or said information related to said code or said second code and/or said information related to said second code displayed on said display of said device so as to be sent by said transmitter to said second entity.

236. The introduction device of claim 231, further comprising a display system that receives at least a part of said set of information from said memory system and displays at least a part of said set of information upon said code allowing access to said set of information present in said memory system.

237. The introduction device of claim 231, further comprising a receiver, said receiver receives at least a part of said set of information from said memory system upon said code allowing access to said set of information present in said memory system.

238. The introduction device of claim 231, wherein said code is readable regardless of the identity of a user that receives it.

239. The system of claim 231, wherein said code is a universal code that can be sent to a plurality of entities besides said first entity and said second entity without needing to know any information regarding said plurality of entities, and can be further sent by any such entities to other entities.

240. The introduction device of claim 231, wherein said introduction device transmits said code wirelessly to said second entity, and wherein said introduction device is a first portable device and/or said second entity receives said code on a second portable device.

241. The introduction device of claim 231, wherein said set of information comprises information selected from the group consisting of: textual information, audio information, video information, music, an image, a computer program, a document, a real time text, audio and video communication.

242. The introduction device of claim 233, wherein said first entity selects content of the information that is used to identify said code and/or said set of information to said first entity and/or said second entity.

243. A method of transferring information between a first entity and a second entity, the method comprising:
retaining a code associated with a set of information to which said first entity has access, wherein said set of information is present in a memory system;
sending said code externally of said introduction device, wherein said code contains information allowing said second entity that received said code access, upon transmission of said code to said memory system, to said set of information present in said memory system.

244. The method of claim 243, further comprising displaying at least a part of said set of information upon said code allowing access to said set of information present in said memory system.

245. The method of claim 243, further comprising transmitting at least a part of said set of information from said memory system to a receiver, said receiver receives at least a part of said set of information from said memory system upon said code allowing access to said set of information present in said memory system.

246. The method of claim 243, further comprising transmitting said code from said second entity to an online account of said second entity that receives said code and transmits said code to said memory system so as to access said set of information.

247. The method of claim 246, further comprising transmitting at least a part of said set of information from said online account, upon accessing said set of information, to a predetermined device of said second entity as indicated in account preferences located in said online account.

248. The method of claim 243, further comprising transmitting said code from said second entity to said memory system, and wherein at least a part of said set of information is transmitted to a device of said second entity as indicated in a transmission to said memory system by said second entity.

249. The method of claim 248, wherein said device of said second entity is an external server that comprises an online account of said second entity.

250. The method of claim 243, wherein said code comprises information and/or is accompanied by information that serves to identify said code and/or said set of information to said first entity and/or said second entity.

251. The method of claim 243, further comprising retaining a second code, said method further comprising selecting either said code or said second code so as to be sent to said second entity.

252. The method of claim 243, wherein said code is readable regardless of the identity of a user that receives it.

253. The system of claim 243, wherein said code is a universal code that can be sent to a plurality of entities besides said first entity and said second entity without needing to know any information regarding said plurality of entities, and can be further sent by any such entities to other entities.

254. The method of claim 243, wherein said introduction device does not require any specific information identifying said second entity in order to successfully transmit said code to said second entity.

255. The method of claim 243, further comprising a display system that receives at least a part of said set of information from said memory system and displays at least a part of said set of information upon said code allowing access to said set of information present in said memory system.

256. The method of claim 243, wherein said introduction device transmits said code wirelessly to said second entity, and wherein said introduction device is a first portable device and/or said second entity receives said code on a second portable device.

257. The method of claim 243, wherein said set of information comprises information selected from the group comprising: textual information, audio information, video information, music, an image, a computer program, a document, a real time text, audio and video communication.

258. The method of claim 250, wherein said first entity selects content of the information that is used to identify said code and/or said set of information to said first entity and/or said second entity.

259. A receiving device for enabling the transfer of information between a first entity and a second entity, the receiving device comprising:
means for receiving from a location external to said means for receiving a code associated with a set of information to which said first entity has access, wherein said set of information is present in an external memory system;
means for storing said code; and
means for transmitting said code to said external memory system, wherein said code contains information allowing said second entity that received said code access to said set of information present in said external memory system.

260. The receiving device of claim 259, wherein said means for receiving receives at least a part of said set of information from said external memory system upon said code allowing access to said set of information present in said external memory system.

261. The receiving device of claim 259, further comprising a second means for receiving, said second means for receiving receives at least a part of said set of information from said external memory system upon said code allowing access to said set of information present in said external memory system.

262. The receiving device of claim 259, further comprising an external server that comprises an online account of said second entity that receives said code and transmits said code to said external memory system so as to access said set of information.

263. The receiving device of claim 262, wherein said online account, upon accessing said set of information, transmits at least a part of said set of information to a predetermined device of said second entity as indicated in account preferences located in said online account.

264. The receiving device of claim 259, wherein said second entity transmits said code to said external memory system, and wherein at least a part of said set of information is transmitted to a device of said second entity as indicated in a transmission to said external memory system by said second entity.

265. The receiving device of claim 264, wherein said device of said second entity is an external server that comprises an online account of said second entity.

266. The receiving device of claim 259, wherein said code comprises information and/or is accompanied by information that serves to identify said code and/or said set of information to said first entity and/or said second entity.

267. The receiving device of claim 259, wherein said code is readable regardless of the identity of a user that receives it.

268. The system of claim 259, wherein said code is a universal code that can be sent to a plurality of entities besides said first entity and said second entity without needing to know any information regarding said plurality of entities, and can be further sent by any such entities to other entities.

269. The receiving device of claim 259, wherein said receiving device sends, besides said code, additional information to said external memory system, wherein said additional information comprises instructions regarding where said code and/or at least a part of said set of information is to be transmitted.

270. The receiving device of claim 259, wherein said receiving device sends, besides said code, additional information to a second means for receiving for an uploading device, wherein said additional information comprises instructions regarding where said code and/or at least a part of said set of information is to be transmitted.

271. The receiving device of claim 270, wherein said second means for receiving receives besides said code additional information, wherein said additional information comprises instructions regarding where said code and/or at least a part of said set of information is to be transmitted.

272. The receiving device of claim 271, wherein said second means for receiving is in communication with a means for storing said additional information, which is in communication with a means for reading said additional information, which is in communication with a means for sending said code and/or at least a part of said set of information in accordance with said additional information.

273. The receiving device of claim 259, further comprising a display system that receives at least a part of said set of information from said external memory system and displays at least a part of said set of information upon said code allowing access to said set of information present in said external memory system.

274. The receiving device of claim 259, wherein said first entity does not require any specific information identifying said receiving device or said second entity in order to successfully transmit said code to said second entity.

275. The receiving device of claim 259, wherein said first entity transmits said code wirelessly to said receiving device, and wherein said first entity transmits said code from a first portable device and/or said receiving device is a second portable device.

276. The receiving device of claim 259, wherein said set of information comprises information selected from the group consisting of: textual information, audio information, video information, music, an image, a computer program, a document, a real time text, audio and video communication.

277. A receiving device for enabling the transfer of information between a first entity and a second entity, the receiving device comprising:
means for receiving from a location external to said means for receiving a code associated with a set of information to which said first entity has access, wherein said set of information is present in an external memory system;
means for storing said code; and
means for interfacing with an external transmitter, where said transmitter sends said code to a location external to said receiving device, and wherein said code contains information allowing said second entity that received said code access, upon transmission of said code to said external memory system, to said set of information present in said external memory system.

278. The receiving device of claim 277, wherein said means for receiving receives at least a part of said set of information from said external memory system upon said code allowing access to said set of information present in said external memory system.

279. The receiving device of claim 277, further comprising a second means for receiving, said second means for receiving receives at least a part of said set of information from said external memory system upon said code allowing access to said set of information present in said external memory system.

280. The receiving device of claim 277, further comprising an external server that comprises an online account of said second entity that receives said code and transmits said code to said external memory system so as to access said set of information.

281. The receiving device of claim 280, wherein said online account, upon accessing said set of information, transmits at least a part of said set of information to a predetermined device of said second entity as indicated in account preferences located in said online account.

282. The receiving device of claim 277, wherein said second entity transmits said code to said external memory system, and wherein at least a part of said set of information is transmitted to a device of said second entity as indicated in a transmission to said external memory system by said second entity.

283. The receiving device of claim 282, wherein said device of said second entity is an external server that comprises an online account of said second entity.

284. The receiving device of claim 277, wherein said code comprises information and/or is accompanied by information that serves to identify said code and/or said set of information to said first entity and/or said second entity.

285. The receiving device of claim 277, wherein said code is readable regardless of the identity of a user that receives it.

286. The system of claim 277, wherein said code is a universal code that can be sent to a plurality of entities besides said first entity and said second entity without needing to know any information regarding said plurality of entities, and can be further sent by any such entities to other entities.

287. The receiving device of claim 277, wherein said receiving device sends, besides said code, additional information to said external memory system, wherein said additional information comprises instructions regarding where said code and/or at least a part of said set of information is to be transmitted.

288. The receiving device of claim 277, wherein said receiving device sends, besides said code, additional information to a second means for receiving of an uploading device, wherein said additional information comprises instructions regarding where said code and/or at least a part of said set of information is to be transmitted.

289. The receiving device of claim 288, wherein said second means for receiving receives besides said code additional information, wherein said additional information comprises instructions regarding where said code and/or at least a part of said set of information is to be transmitted.

290. The receiving device of claim 289, wherein said second means for receiving is in communication with a means for storing said additional information, which is in communication with a means for reading said additional information, which is in communication with a means for sending said code and/or at least a part of said set of information in accordance with said additional information.

291. The receiving device of claim 277, further comprising a display system that receives at least a part of said set of information from said external memory system and displays at least a part of said set of information upon said code allowing access to said set of information present in said external memory system.

292. The receiving device of claim 277, wherein said first entity does not require any specific information identifying said means for receiving or said second entity in order to successfully transmit said code to said second entity.

293. The receiving device of claim 277, wherein said first entity transmits said code wirelessly to said receiving device, and wherein said first entity transmits said code from a first portable device and/or said receiving device is a second portable device.

294. The receiving device of claim 277, wherein said set of information comprises information selected from the group consisting of: textual information, audio information, video information, music, an image, a computer program, a document, a real time text, audio and video communication.

295. A receiving device for enabling the transfer of information between a first entity and a second entity, the receiving device comprising:
means for receiving from a location external to said means for receiving a code associated with a set of information to which said first entity has access, wherein said set of information is present in an external memory system;
means for storing said code; and
means for transmitting said code to a location external to said receiving device, wherein said code contains information allowing said second entity that received said code access, upon transmission of said code to said external memory system, to said set of information present in said external memory system.

296. The receiving device of claim 295, wherein said means for receiving receives at least a part of said set of information from said external memory system upon said code allowing access to said set of information present in said external memory system.

297. The receiving device of claim 295, further comprising a second means for receiving, said second means for receiving receives at least a part of said set of information from said external memory system upon said code allowing access to said set of information present in said external memory system.

298. The receiving device of claim 295, further comprising an external server that comprises an online account of said second entity that receives said code and transmits said code to said external memory system so as to access said set of information.

299. The receiving device of claim 298, wherein said online account, upon accessing said set of information, transmits at least a part of said set of information to a predetermined device of said second entity as indicated in account preferences located in said online account.

300. The receiving device of claim 295, wherein said second entity transmits said code to said external memory system, and wherein at least a part of said set of information is transmitted to a device of said second entity as indicated in a transmission to said external system memory by said second entity.

301. The receiving device of claim 300, wherein said device of said second entity is an external server that comprises an online account of said second entity.

302. The receiving device of claim 295, wherein said code comprises information and/or is accompanied by information that serves to identify said code and/or said set of information to said first entity and/or said second entity.

303. The receiving device of claim 295, wherein said receiving device sends, besides said code, additional information to said external memory system, wherein said additional information comprises instructions regarding where said code and/or at least a part of said set of information is to be transmitted.

304. The receiving device of claim 295, wherein said receiving device sends, besides said code, additional information to a second means for receiving of an uploading device, wherein said additional information comprises instructions regarding where said code and/or at least a part of said set of information is to be transmitted.

305. The receiving device of claim 304, wherein said second means for receiving receives, besides said code, additional information, wherein said additional information comprises instructions regarding where said code and/or at least a part of said set of information is to be transmitted.

306. The receiving device of claim 305, further comprising a means for storing said additional information, which is in communication with a means for reading said additional information, which is in communication with a means for sending said code and/or at least a part of said set of information in accordance with said additional information.

307. The receiving device of claim 295, further comprising a display system that receives at least a part of said set of information from said external memory system and displays at least a part of said set of information upon said code allowing access to said set of information present in said external memory system.

308. The receiving device of claim 295, wherein said first entity does not require any specific information identifying said means for receiving or said second entity in order to successfully transmit said code to said receiving device.

309. The receiving device of claim 295, wherein said first entity transmits said code wirelessly to said receiving device, and wherein said first entity transmits said code from a first portable device and/or said receiving device is a second portable device.

310. The receiving device of claim 295, wherein said set of information comprises information selected from the group consisting of: textual information, audio information, video information, music, an image, a computer program, a document, a real time text, audio and video communication.

311. A system for enabling the transfer of information between a first entity and a second entity and enabling said first entity to manage information, the system comprising:
a receiver for receiving a code associated with a set of information to which said first entity has access from a location external to said receiver;
a memory that is in communication with said receiver and stores said code;
a transmitter in communication with said memory, where said transmitter sends said code to an external memory system in which said set of information is present, and where said code contains information allowing said second entity that received said code access to said set of information present in said external memory system;
a second memory of said second entity that stores at least a part of said set of information acquired through said code and said external memory system; and
an output for providing at least a part of said set of information to said second entity and/or said first entity.

312. The system of claim 311, further comprising a display system that receives at least a part of said set of information from said external memory system and displays at least a part of said set of information upon said code allowing access to said set of information present in said external memory system.

313. The system of claim 311, wherein said receiver receives at least a part of said set of information from said external memory system upon said code allowing access to said set of information present in said external memory system.

314. The system of claim 311, further comprising a second receiver, said second receiver receives at least a part of said set of information from said external memory system upon said code allowing access to said set of information present in said external memory system.

315. The system of claim 311, wherein said first entity does not require any specific information identifying said second entity in order to successfully transmit said code to said second entity.

316. The system of claim 311, further comprising an online account.

317. The system of claim 316, wherein said online account, upon accessing said set of information, transmits at least a part of said set of information to a predetermined device as indicated in account preferences located in said online account.

318. The system of claim 311, wherein said code comprises information and/or is accompanied by information that serves to identify said code and/or said set of information to said first entity and/or said second entity.

319. The system of claim 311, wherein said transmitter sends, besides said code, additional information to said external memory system, wherein said additional information comprises instructions regarding where said code and/or at least a part of said set of information is to be transmitted.

320. The system of claim 319, wherein said receiver receives, besides said code, additional information, wherein said additional information comprises instructions regarding where said code and/or at least a part of said set of information is to be transmitted.

321. The system of claim 320, wherein said receiver is in communication with a thirdmemory for storing said additional information, which is in communication with a reading device that reads said additional information, which is in communication with said transmitter for sending said code and/or at least a part of said set of information in accordance with said additional information.

322. The system of claim 311, further comprising means for sending, besides said code, additional information to a second reciver, wherein said additional information comprises instructions regarding where said code and/or at least a part of said set of information is to be transmitted.

323. The system of claim 311, wherein said first entity transmits said code wirelessly to said second entity, and wherein said first entity transmits said code from a first portable device and/or said second entity receives said code on a second portable device.

324. The system of claim 311, wherein said set of information comprises information selected from the group selected from: textual information, audio information, video information, music, an image, a computer program, a document, a real time text, audio and video communication.

325. A system for enabling the managing of information transferred between a first entity and a second entity and enabling said first entity to manage information, the system comprising:
means for receiving a code associated with a set of information to which said first entity has access from a location external to said means for receiving;
means for storing said code;
means for sending said code to an external memory system in which said set of information is present, said code contains information allowing said second entity that receives said code access to said set of information present in said external memory system;
means for retaining in a memory of said second entity at least a part of said set of information acquired through said code and said external memory system; and
means for providing at least a part of said set of information to said second entity and/or said first entity.

326. The system of claim 325, further comprising a display system that receives at least a part of said set of information from said external memory system and displays at least a part of said set of information upon said code allowing access to said set of information present in said external memory system.

327. The system of claim 325, wherein said means for receiving receives at least a part of said set of information from said external memory system upon said code allowing access to said set of information present in said external memory system.

328. The system of claim 325, further comprising a second means for receiving, said second means for receiving receives at least a part of said set of information from said external memory system upon said code allowing access to said set of information present in said external memory system.

329. The system of claim 325, wherein said first entity does not require any specific information identifying said second entity in order to successfully transmit said code to said second entity.

330. The system of claim 325, further comprising an online account.

331. The system of claim 330, wherein said online account, upon accessing said set of information, transmits at least a part of said set of information to a predetermined device as indicated in account preferences located in said online account.

332. The system of claim 325, wherein said code comprises information and/or is accompanied by information that serves to identify said code and/or said set of information to said first entity and/or said second entity.

333. The system of claim 325, further comprising means for sending, besides said code, additional information to the external memory system, wherein said additional information comprises instructions regarding where said code and/or at least a part of said set of information is to be transmitted.

334. The system of claim 333, wherein said means for receiving receives, besides said code, additional information, wherein said additional information comprises instructions regarding where said code and/or at least a part of said set of information is to be transmitted.

335. The system of claim 334, further comprising a means for storing said additional information, which is in communication with a means for reading said additional information, which is in communication with a means for sending said code and/or at least a part of said set of information in accordance with said additional information.

336. The system of claim 325, further comprising means for sending, besides said code, additional information to a second means for receiving, wherein said additional information comprises instructions regarding where said code and/or at least a part of said set of information is to be transmitted.

337. The system of claim 325, wherein said first entity transmits said code wirelessly to said second entity, and wherein said first entity transmits said code from a first portable device and/or said second entity receives said code on a second portable device

338. The system of claim 325, wherein said set of information comprises information selected from the group consisting of: textual information, audio information, video information, music, an image, a computer program, a document, a real time text, audio and video communication.

339. A method of transferring information between a first entity and a second entity and enabling said first entity to manage information, the method comprising:
receiving a code associated with a set of information to which said first entity has access from a location external to a means for receiving;
storing said code;
sending said code to an external memory system in which said set of information is present, said code contains information allowing said second entity that receives said code access to said set of information present in said external memory system;
retaining in a memory of said second entity at least a part of said set of information acquired through said code and said external memory system; and
providing at least a part of said set of information to said second entity and/or said first entity.

340. The method of claim 339, further comprising a display system that receives said at least a part of set of information from said external memory system and displays at least a part of said set of information upon said code allowing access to said set of information present in said external memory system.

341. The method of claim 339, wherein said means for receiving receives at least a part of said set of information from said external memory system upon said code allowing access to said set of information present in said external memory system.

342. The method of claim 339, further comprising a second means for receiving, said second means for receiving receives at least a part of said set of information from said external memory system upon said code allowing access to said set of information present in said external memory system.

343. The method of claim 339, wherein said first entity does not require any specific information identifying said second entity in order to successfully transmit said code to said second entity.

344. The method of claim 339, further comprising an online account.

345. The method of claim 344, wherein said online account, upon accessing said set of information, transmits at least part of said set of information to a predetermined device as indicated in account preferences located in said online account.

346. The method of claim 339, wherein said code comprises information and/or is accompanied by information that serves to identify said code and/or said set of information to said first entity and/or said second entity.

347. The method of claim 339, further comprising sending, besides said code, additional information to said external memory system, wherein said additional information comprises instructions regarding where said code and/or at least a part of said set of information is to be transmitted.

348. The method of claim 347, wherein said means for receiving receives, besides said code, additional information, wherein said additional information comprises instructions regarding where said code and/or at least a part of said set of information is to be transmitted.

349. The method of claim 348, further comprising storing said additional information, reading said additional information, and sending said code and/or at least a part of said set of information in accordance with said additional information.

350. The method of claim 339, further comprising sending, besides said code, additional information to a second means for receiving, wherein said additional information comprises instructions regarding where said code and/or at least a part of said set of information is to be transmitted.

351. The method of claim 339, wherein said first entity transmits said code wirelessly to said second entity, and wherein said first entity transmits said code from a first portable device and/or said second entity receives said code on a second portable device.

352. The method of claim 339, wherein said set of information comprises information selected from the group consisting of: textual information, audio information, video information, music, an image, a computer program, a document, a real time text, audio and video communication.

353. A method for transferring information between a first entity and a second entity, the method comprising:
presenting a set of information to which said first entity has access in a memory that is at a location that does not coincide with a location of said first entity;
sending second entity delivery information to said first entity that identifies an element to which said code and/or at least a part of set of information is to be sent; and
sending a code to said element as said delivery information directs, wherein said code contains information that allows said second entity access, upon transmission of said code to said memory, to said set of information present in said memory.

354. The method of claim 353, wherein said element is selected from the group consisting of: said memory, an online account and a device external to said memory.

355. The method of claim 353, further comprising displaying at least a part of said set of information upon said code allowing access to said set of information present in said memory.

356. The method of claim 353, further comprising transmitting said code and/or at least a part of set of information to an online account of said second entity.

357. The method of claim 353, wherein said code comprises information and/or is accompanied by information that serves to identify said code and/or said set of information to said first entity and/or said second entity.

358. The method of claim 353, wherein said second entity does not require any specific information identifying said first entity in order to successfully transmit said delivery instructions to said first entity.

359. The method of claim 353, wherein said second entity transmits said delivery information wirelessly to said first entity, and wherein said second entity transmits said delivery information from a first portable device and/or said first entity receives a transmission of said delivery information from a second portable device.

360. The method of claim 353, wherein said set of information comprises information selected from the group consisting of: textual information, audio information, video information, music, an image, a computer program, a document, a real time text, audio and video communication.

361. A system for transferring information between a first entity and a second entity, the system comprising:
a set of information to which said first entity has access and said set of information is present in a memory that is at a location that does not coincide with a location of said first entity;
a receiving device of said second entity that is incapable of transmitting information to said memory;
an introduction device that comprises a code, wherein said introduction device comprises a receiver that receives delivery information from said receiving device that identifies an element of said second entity to where said code and/or at least a part of said set of information is to be sent, a transmitter transmits said code to said element as directed by said delivery information, wherein said code contains information that allows second entity access, upon transmission of said code to said memory, to said set of information present in said memory.

362. The system of claim 361, wherein said element is selected from the group consisting of: said memory, an online account and a device external to said memory.

363. The system of claim 361, further comprising a display system that receives at least a part of said set of information from said memory and displays at least a part of said set of information upon said code allowing access to said set of information present in said memory.

364. The system of claim 361, wherein said second entity does not require any specific information identifying said first entity in order to successfully transmit said delivery information to said first entity.

365. The system of claim 361, wherein said code comprises information and/or is accompanied by information that serves to identify said code and/or said set of information to said first entity and/or said second entity.

366. The system of claim 361, wherein said introduction device comprises a display that displays said code and/or information related to said code.

367. The system of claim 361, wherein said set of information comprises information selected from the group consisting of: textual information, audio information, video information, music, an image, a computer program, a document, a real time text, audio and video communication.
